(19) United States
(12) Patent Application Publication
(10) Pub. No.: US 2006/0064342 A1
(43) Pub. Date: Mar. 23, 2006

(54) Internet based qualitative research method and system and Synchronous and Asynchronous audio and video message board

(75) Inventors: Renee Frengut, Boca Raton, FL (US); Jack Galyan, Wellington, FL (US)

Correspondence Address: Daniel S. Polley. Esq.;DANIEL S. POLLEY, P.A., 1215 East Broward Boulevard, Fort Lauderdale, FL, 33301, US

(73) Assignee: QUALITY RESOURCES WORLDWIDE, LLC.

(21) Appl. No.: 10/990,856

(22) Filed: Nov. 17, 2004

Related U.S. Application Data
(63) Continuation-in-part of application No. 10/972,714, filed on Oct. 25, 2004.
Application No. 10/972,714 is a continuation-in-part of application No. 09/883,590, filed on Jun. 18, 2001.

(51) Int. Cl. G06F 17/30

(52) U.S. Cl. 705/10

(57) ABSTRACT

A system and method for conducting an online research study from a host machine over a distributed computer network. Through their computers participants attend the online research study conducted over a distributed computer network and our in communication with a moderator using a participant interface having an audio/video captive mechanism connected thereto. Each participant is not required to be physically present at a same geographical location as a moderator for the online research study. The system permits for substantially real time audio/video communication between the moderator and participants during the online research study. The online research study can also be streamed in real time, while ongoing, one or more client computers who also are not restricted to any geographical location. Two-way communication between the moderator and a designated client can also be permitted while the online research session is being conducted. In another embodiment further embodiment, the system provides audio and video recording capabilities that can combine or encompass any various combinations thereof and which can permit for Synchronous and Asynchronous audio and video message boards.

This application is a continuation-in-part of U.S. application Ser. No. 10/972,714, filed Oct. 25, 2004, which is a continuation-in-part of U.S. application Ser. No. 09/883,590, filed Jun. 18, 2001, all of the above-identified applications are incorporated by reference.

### FIELD OF THE INVENTION

The present invention relates generally to the field of market research. More particularly, the present invention relates to qualitative market research methods and systems conducted over a distributed network, such as a distributed computer network. Furthermore, the market research participants can be dynamically chosen so as to ensure that the final pool of market research participants most closely resembles the consumer or potential consumer base the sponsoring company wishes to probe.

### BACKGROUND OF THE INVENTION

Market research studies are generally qualitative or quantitative in nature. Quantitative studies consist of a large number of samples with results that are easily tabulated for statistical purposes. Qualitative studies, however, comprise a smaller sample set wherein the results consist of open-ended discussions which provide substantive feedback that is often directive in nature. These discussions are often between a professional moderator and a representative sample of the sponsoring company's current and/or potential consumer base. Quantitative studies usually present participants with close-ended questions having pre-formulated, and consequently easily analyzed, responses. While the benefit of quantitative research is that it is statistically projectable, the benefit of qualitative research is that it is directional and substantive. Usually, qualitative studies involve a skilled moderator who creates an in-depth and flexible interview structure, which is nonexistent in quantitative studies.

Currently, qualitative moderators conduct interviews in research facilities globally located. Typically these facilities are located in major metropolitan areas along major airline routes. Consequently, attracting qualitative research participants from small or medium sized towns has proven difficult. Small or medium sized town participants might need to drive for hours or need to take two or more airplanes, simply to reach the study. Asking focus group participants to make such travel sacrifices has proven not only impractical, but also extremely costly. As a result, the small to medium size-town segment of the sponsoring client's consumer or potential consumer base is often times not probed.

However, the benefit of these research facilities is that they equip interview rooms with one-way mirrors and intimate settings such that participant reaction is easily observed by the sponsoring client. The sponsoring client represents the company gauging consumer response to the company's service or product. Qualitative studies typically involve a moderator who conducts an interview with 1-10 participants whom the sponsoring company has chosen as a representative population of the sponsoring company's current or potential consumer base. Consequently, while qualitative studies are generally more informative than quantitative studies, they are also more expensive on a per interview basis, time consuming and travel intensive than quantitative studies.

A number of companies have attempted to replicate the qualitative research experience over the Internet. However, to date, prior art attempts have been unsuccessful. None of the Internet based market research studies have created a virtual market research study or a virtual communication facility. Often times, the video stream is slow, the picture quality is poor, and more often than not the benefits of qualitative market research studies have been compromised. For example, many existing Internet based qualitative market research studies are conducted using online chat, whereby moderators and participants communicate through keystrokes. However, this question and answer format eliminates participant body language and facial expressions from the market research study. Another, prior art attempt involves taping a study in progress and transmitting the signal to the sponsoring client across the Internet or phone lines. One problem with this type of focus group is that participant travel costs and time are not alleviated. Participants still must travel to get to the focus group study and consequently middle to small town size participants will be at large absent from the study. Some examples of these Internet based prior art techniques include: www.greenfieldonline.com; www.harrisinteractive.com; and www.activegroup.net: and www.e-focusgroups.com.

Greenfield Online is one Internet based market research company. Greenfield Online allows sponsoring clients to view a chat room market research group in real time or provides sponsoring clients with market research study transcripts. There is no audio or video component to the chat room. Consequently, informative facial expressions, body expressions, intonations, etc. are lost with the Greenfield Online technique. Moreover, there is no way to verify that the participant responding to the moderator's questions is in fact who the sponsoring client expects the participant to be. Participant veracity is critical to the sponsoring client who wants an accurate sample of their current or potential consumer base polled. With the Greenfield Online approach, there is no way to ensure that demographic information and market research data answers match the participant typing in the chat room.

Another prior art technique is represented with the Harris Interactive prior art. Like Greenfield Online, Harris Interactive enables an “online” chat room market research group. Thus, Harris Interactive, like the Greenfield Online approach censors participant body language from the study. Besides the “online” chat room format, Harris Interactive offers a bulletin board style focus group. With the bulletin board style focus group, focus group questions remain indefinitely on the Web site for participants to answer at their leisure. However, as with the chat room set-up, the bulletin board format results in first hand participant reaction loss.

As mentioned above, another typical internet-based qualitative research study involves simply transmitting a focus group signal over the Internet or phone lines to a sponsoring client's device. Activegroup.com is an example of this type of prior art. Essentially, the sponsoring client views the focus group through the video-conferencing facilities of a research facility. Activegroup does not eliminate travel burdens for the participants. Essentially, Activegroup is a taped market research group. As a result, Activegroup presents the same participant pool constraints as traditional focus groups. The virtual focus group or virtual communication facility experience has not been recreated. The moderators and participants do not communicate through audio/video capturing mechanisms and consequently this video conferenced focus group is not easily modifiable. For example, should the sponsoring client wish that focus group participants not observe the reactions of other participants mid-study, the sponsoring client can not easily mandate a mid-study format change without requiring physically separating participants in separate rooms. With the videotaped focus groups, such as Activegroup, the focus group itself is not virtual. The participants are not participating over the Internet and moderators are not communicating over the Internet. This virtual environment is critical because it facilitates virtual conversations between participants and moderators and between moderators and sponsoring clients. The virtual environment allows sponsoring clients to modify the focus group mid-study without much added inconvenience. The sponsoring client may wish the moderator to ask more poignant questions; focus the market research study on a particular participant; compare participant response when participant reactions are censored from one another. The virtual focus group easily facilitates mid-study changes, which taped focus groups such as Activegroup cannot promote.

Finally, e-focusgroups.com provides the same chat and bulletin board typing chat formats as Greenfield Online and Harris Interactive but e-focusgroups offers a “secured” environment. Once again video and audio capturing mechanisms are absent from e-focusgroup.com. Accordingly, first hand observable accounts of participant reaction are lost, as is the mid-dialogue study alteration capability.

Accordingly, it would be advantageous to provide an improved qualitative research method and system recreating a virtual communication facility such that the time commitment and costs are minimized without comprising the diverse participant pool and the substantive feed-back provided by the behavior patterns and verbal responses observed by the sponsoring client.

### SUMMARY OF THE INVENTION

A preferred embodiment of the present invention is a qualitative market research system and method conducted over a distributed computer network wherein each market research participant is dynamically chosen ensuring an ideal consumer reflection of the sponsoring company's current or potential consumer base. The qualitative system and method according to a preferred embodiment involves a moderator and a market research participant communicating through devices having distributed computer network access and audio/video capturing mechanisms or devices. In addition, besides the moderators and participants, a preferred embodiment envisions the sponsoring client observing both participant responses and images through a separate device also connected to the distributed computer network.

A preferred embodiment of the present invention entails market research participants and moderators logging onto a Web site at a given time with a specific market research ID and pass code. Once logged onto the network, market research participants and moderators participate in a virtual focus group in which both parties view: each other and the product or service being evaluated. Sometimes, the participants also view images and responses of other participants depending on the sponsoring companies directive. Consequently, on each participant's screen there are multiple video images: the participant's own image, the moderator's image, the stimulus (presented on separate Web pages), and the participant's submitted response to the stimulus. Similarly, each moderator also views multiple images. The moderator views each participant's image and responses. When the sponsoring client is involved, the sponsoring client observes the entire study anonymously thereby simulating the one-way mirror experience of research facilities. Consequently, the sponsoring client's computer need not have an audio/video capturing mechanism, but should have an observing mechanism and communication device for dialogues with the moderator.

Prior to conducting the qualitative study, a preferred embodiment of the present invention entails dynamically choosing focus group and individual interview participants over a distributed computer network such that an ideal consumer market pool is accumulated. First, a diverse group of potential candidates are invited through telephones, direct mailings, e-mail advertisements, or other such modes of direct solicitation. Once a diverse potential candidate pool has been acquired, the potential candidate pool is compared with the ideal consumer pool dictated by a template often times provided by the sponsoring company. Candidates who most closely resemble participants in the ideal consumer pool at any given time are selected and compensated while unselected potential candidates are rejected without pay. The candidates receive audio/video capturing mechanisms and are instructed to log onto the market research study at a given time. Unlike prior art techniques which eliminated large segments of the consumer or potential consumer pool, due to travel constraints, the present embodiment taps into all segments of the consumer pool. The only prerequisite is that participants have Internet access. The Internet access can be located at a number of locations, which include but are not limited to, home, work, research facilities, and apartment complexes. With Internet as the only requirement, market research study costs are significantly reduced.

Thus, the present invention also provides an improved qualitative market research method and system such that candidates for the market research study are dynamically chosen and selected over a distributed computer network such that at any given time the set of market research candidates optimally fits a predefined preference specified by the client sponsoring the qualitative market research study which are verifiable by the real-time audio and video input from the candidates.

Participants represent a first portion of the set of candidates and are the consumers who actually partake in the market research study. Participant presence is monitored and verified throughout the market research study. Participants whose presence has been verified will be paid a first sum. Candidates, will also be paid, but the candidate's sum will be a reduced version of the participant's first sum.

### BRIEF DESCRIPTION OF THE DRAWINGS

The foregoing and other features of the present invention will be more readily apparent from the following detailed description and drawings of illustrative embodiments of the invention wherein like reference numbers refer to similar elements throughout several views and in which;

FIG. 1a is an exemplary flow diagram depicting the enrollment process for a general population sample in accordance with one embodiment of the present invention;

FIG. 1b is an exemplary flow diagram depicting the enrollment process for a corporate/membership population sample in accordance with one embodiment of the present invention;

FIG. 2 is an exemplary flow diagram depicting the process involved in conducting a qualitative study in accordance with one embodiment of the present invention;

FIG. 3 represents an exemplary network arrangement of the qualitative study in accordance with one embodiment of the present invention;

FIG. 4 represents an exemplary flow diagram depicting the process involved in dynamically selecting a set of candidates;

FIG. 5 represents an exemplary network arrangement for dynamically choosing a market research group in accordance with one embodiment of the present invention;

FIG. 6 represents an exemplary template system for dynamically modifying a template to select a set of candidates in accordance with another embodiment of the present invention;

FIG. 7 represents a screen shot displaying the Moderator Remote Viewer (“MRV”) activated and in action during a research session;

FIG. 7a represents another screen shot showing the moderator chat window;

FIG. 7b represents a screen show showing a large view of the moderators remote viewer chat web application.

FIG. 8 represents a screen shot displaying and index of multiple research events contained on the server of the present invention system;

FIG. 8a represents a screen shot of a moderators entry center in accordance with the present invention system;

FIG. 8b represents a screen shot of a respondent/participant entry screen in accordance with the present invention system;

FIG. 8c represents a screen shot of a moderators web application control center in accordance with the present invention system;

FIG. 8d represents a screen shot of moderators main menu once logged in to the present invention system;

FIG. 9 represents a view or display of the note or other communication from the note passing feature of the system as seen by the moderator/interviewer on the screen;

FIG. 10 represents a screen shot of a client designee backroom in accordance with the present invention system;

FIG. 11 represents a screen shot of a client passive viewer backroom in accordance with the present invention system;

FIG. 11a represents another screen shot of a client designee backroom in accordance with the present invention system;

FIG. 12 represents a screen shot showing a live feed side-by-side stimuli using the present invention system;

FIG. 13 represents an encrypted web page that is shown to the participants during a focus group session being conducted by the present invention system;

FIG. 14 represents a screen shot of an encrypted HTML stimuli source code'

FIG. 15 represents a Voice over IP module for the Backroom in accordance with the present invention system;

FIG. 16 represents a screen shot showing the Voice over IP module activated in a client Backroom;

FIG. 17 illustrates a data flow chart showing the flow of a typical room with Backroom streaming activated in accordance with the present invention system;

FIG. 18 illustrates a tech center configuration in accordance with the present invention system;

FIG. 19 illustrates a block diagram showing one hardware/software embodiment for the present invention system;

FIG. 20 illustrates the steps involved in performing Ethnographic research in accordance with the present invention;

FIG. 21 illustrates the two-way communication link between the call center server and server database a further embodiment of the present invention system used as a synchronous and asynchronous audio and video message board;

FIG. 22 illustrates a call center server application in standby mode waiting for callers in accordance with the synchronous and asynchronous audio and video message board embodiment of the present invention;

FIG. 23 illustrates the endpoint application on a callers/participants' computer in accordance with the synchronous and asynchronous audio and video message board embodiment of the present invention;

FIG. 24 illustrates the call center server application taking a call from a caller/participant in accordance with the synchronous and asynchronous audio and video message board embodiment of the present invention;

FIG. 25 illustrates a client viewing area for the synchronous and asynchronous audio and video message board embodiment of the present invention which can be a special or designated HTML website to listen in on a live interview;

FIG. 26 illustrates a client communications system portion of the website of FIG. 25 to allow a client to interface with a moderator during the live interview;

FIG. 27 illustrates an upclose view of the client communications system;

FIG. 28 illustrates a moderator and client view of an async webpage to review and play all responses from participant callers for topic(s);

FIG. 29 illustrates a participant view of an async webpage to leave a message response to the tope;

FIG. 30 illustrates a participant view of an async webpage to leave a message response to the topic with the record button for leaving a reply emphasized in the drawings;

FIG. 31 illustrates a flow diagram for a live IP Voice message board in accordance with the present invention; and

FIG. 32 illustrates a flow diagram for a live IP Audio-Video message board demonstrating the flow of a typical room with backroom streaming activated.

### DETAILED DESCRIPTION OF THE PREFERRED EMBODIMENTS

By way of overview, one embodiment of the present invention involves a moderator and a market research participant participating in a virtual focus group or individual interview. The parties communicate through devices having distributed computer access and audio/video capturing mechanisms. Sometimes, the sponsoring client observes the virtual communication facility through a separate device also connected to the distributed computer network. In accordance with a preferred embodiment, the qualitative study is conducted such that when market research participants, moderators, and sponsoring clients log onto a given Web site at a predetermined time all parties involved can observe the study in real time.

The market research participants are selected in accordance with a further embodiment of the present invention. According to a preferred embodiment, market research candidates are solicited either directly or indirectly. The candidates are then chosen from an accumulated candidate pool such that the chosen participants most closely represent the ideal consumer base specified by a template usually provided by the sponsoring client.

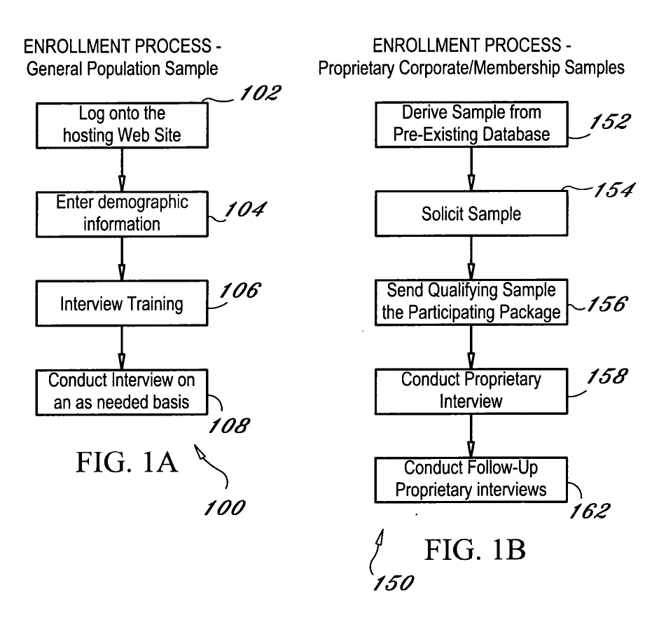

FIG. 1 a represents an exemplary flow diagram depicting the enrollment process for a general population sample in accordance with a preferred embodiment of the present invention.

In step 102, the potential candidate logs onto the Web site hosting the qualitative study. In step 104, the potential candidate enters demographic information such as, but not limited to, geographical location, profession, education, salary, age, gender, political affiliation, etc. In step 106, the potential candidate is trained so that the potential candidate is accustomed to the virtual focus group environment. For instance, one embodiment instructs the potential candidates on how market research studies are conducted and how each party participates. In step 108, follow-up potential candidate interviews are conducted on an as-needed basis should a sponsoring client wish to obtain further information in an effort to finalize the study's candidate pool.

FIG. 1b represents an exemplary flow diagram depicting the enrollment processes for proprietary corporate/membership population samples in accordance with one embodiment of the present invention. In step 152, market research candidates are accumulated from various preexisting databases such as, but not limited to, customer lists, subscriber membership lists, and Web site visitors. In step 154, the market research potential candidate pool is freshly solicited such as through e-mail, direct mail advertisements, and new Web site visitors. In step 156, market research candidates who qualify for the participant pool are sent a participating package. This participating package includes an audio/video capturing device, software for conducting the virtual focus group, and instructions on how to use both the software and the audio/video sensing mechanism. In step 158, proprietary interviews are conducted amongst market research potential participants and the moderator. Should the sponsoring client request further information from a potential participant, follow-up proprietary interviews are conducted in step 162. The proprietary follow-up interview environment conducted in step 162 generally consists of a one-on-one or group “chat room” setting.

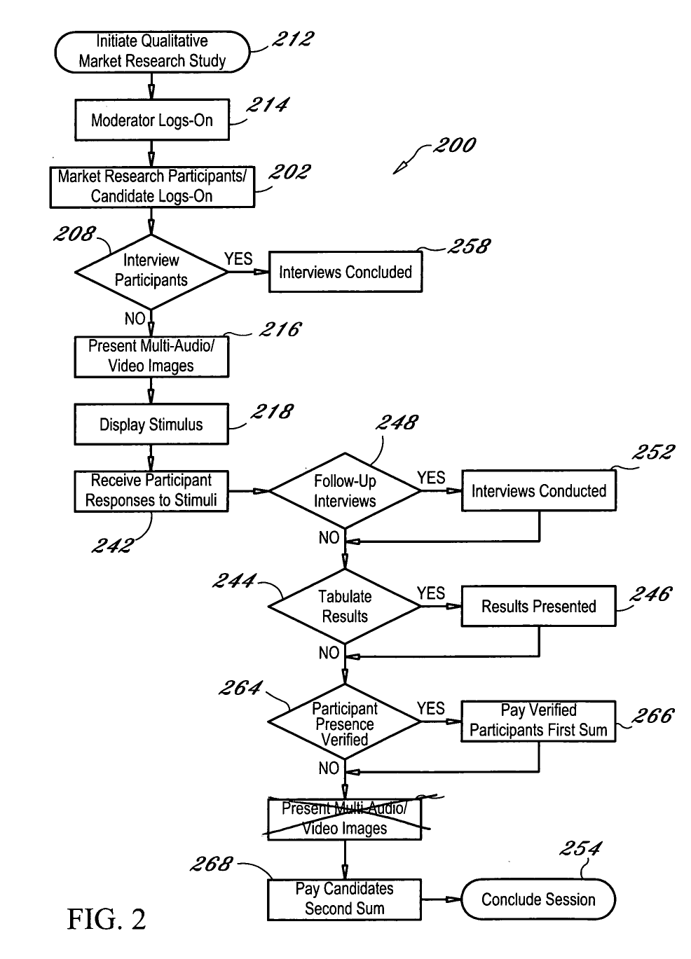

FIG. 2 represents an exemplary flow diagram depicting the process involved in conducting a qualitative study in accordance with one embodiment of the present invention. In step 212, a market research study is initiated amongst the moderator, the candidates, and often an observing, sponsoring company. First, in step 214, the moderator logs onto the Web site hosting the particular market research study using a special market research ID and pass code. During the same time period, in step 202, the market research candidates and participants log onto the Web site hosting the market research study with the participant's own market research ID and pass code. The market research participants comprise a reduced first portion of the set of candidates. After both the market research participants/candidates and moderator have logged on in steps 214 and 202, the moderator in step 208 is asked in step 208 whether or not the moderator wishes to conduct a preliminary interview with anyone. If so, in step 258 an interview is conducted. If not, the study continues with step 216. In step 216, both the moderator and the market research participants are presented with multiple screens in which audio/video images of the moderator and market research participants are displayed. While the moderator has an audio/video image of each market research participant, the market research participant has an audio/video image of themselves, the moderator, and potentially even audio/video images of other participants and their responses. In step 218, a stimulus which represents the product or service the sponsoring company wishes to evaluate is displayed to the participants by the moderator. The stimuli can be, but is not limited to, products, packaging, photos, concept statements, illustrations and/or full motion videos. After the market research participants are shown the stimulus in step 218, they are asked to submit responses to the stimulus in step 242.

Once the session is over, the sponsoring company is asked in step 248, whether the sponsoring client wishes to conduct follow-up interviews with any of the market research participants. Should the sponsoring client wish for follow-up interviews in step 248, the follow-up interviews are conducted in step 252. If not, the sponsoring company is asked in step 244, whether they wish to tabulate the market research study. Should the sponsoring client wish to tabulate the results in step 244 in step 246, the tabulation is presented. If not, then in step 264 the participants' presence throughout the market research study is verified. If the participants have been present throughout the study in step 264, then the participants are paid a first sum of money in step 266.

However, if the participants have not been present throughout the study in step 264, then the candidates are paid in step 268. Sponsoring company's discretion determines whether participants with unverifiable presence receive a second sum like the candidates or receive no payment. Candidates receive a reduced second sum. Candidates are paid less than participants because while they logged onto the study at the predetermined time, ultimately the candidates were not chosen to participate in the study. If the sponsoring client does not want follow-up proprietary interviews, the session ends in step 254.

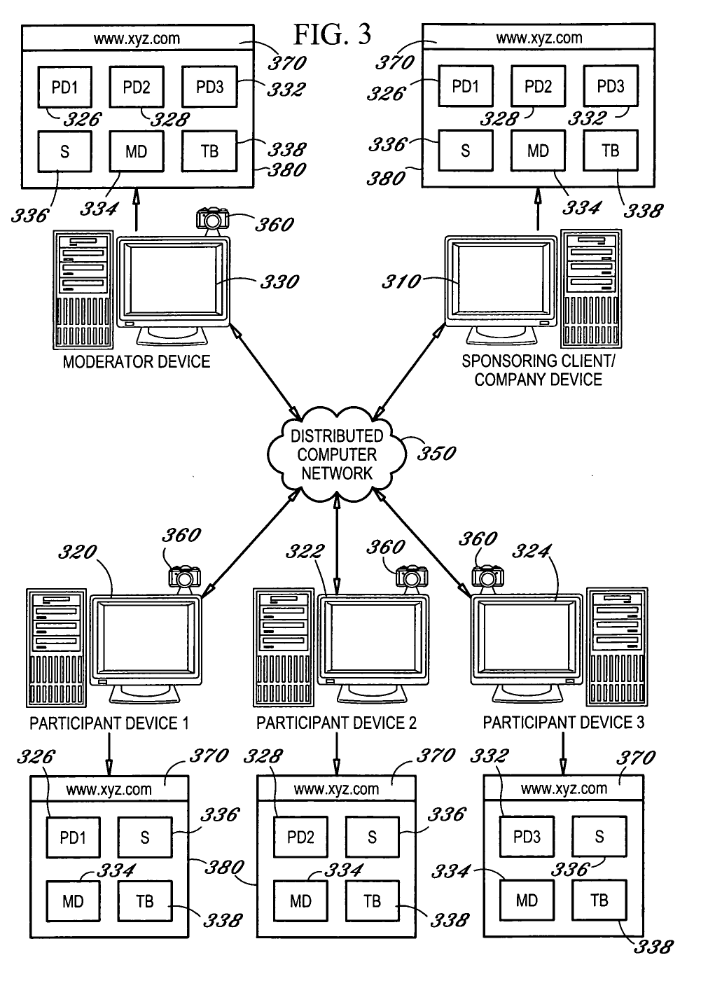

FIG. 3 represents an exemplary network arrangement of a market research study in accordance with one embodiment of the present invention. Then network arrangement 300 is shown in FIG. 3 with three participating market research identities: the moderator, the sponsoring client, and the market research participants. The moderator acts through a moderator device 330, which generally speaking is a PC or a workstation which has Internet or distributed computer network 350 access. In addition, each moderator device 330 has a audio/video capturing device 360 such as a web camera. As can be seen in FIG. 3, the moderator logs onto the hosting market research web site 370, in this case represented by www.xyz.com, and upon entering the hosting market research Web site 370, enters a market research ID and pass code. Upon accessing the market research study, the moderator is presented with a plurality of audio/video participant images as well as written participant responses in substantially real time.

The sponsoring client also observes the market research study through a sponsoring client device 310 which unlike the moderating device 330 is without an active audio/video capturing device. Therefore, from the participant's perspective the sponsoring client silently and anonymously observes the study. Moreover, it should noted that while the sponsoring client does not communicate not with the participants, the sponsoring client through the sponsoring client device 310 can and does communicate with the moderator. The distributed computer access 350 facilitates virtual moderator/sponsoring client conversations. The sponsoring client device 310, like the monitor's device 330, has access to the distributed computer network 350 so that the observing client can log on to the market research study at a given time to observe. In addition, similar to the moderator, the sponsoring client also when logging on to the study views multiple video images which are streamed in substantially real time. In the sponsoring client's web browser 380, multi-video images are depicted by the PD1 box 326, the PD2 box 328, the PD3 box 332 and the MD box 334.

The final party to the market research study is the market research participants. In FIG. 3, the participants also sit at user devices connected to the distributed computer network 350. The participant user devices are labeled as participant device 1 (“PD 1”), 320, participant device 2 (“PD 2”), 322 and participant device 3, (“PD 3”) 324. Each participating device is accompanied with an audio/video capturing device 360 and access to the distributed computer network 350. Each market research participant logs onto the Web site hosting the market research study 370 just as the sponsoring client and the moderator had before them. Also once again, the participants view multiple video images in their web browser 380. Participant 1 who is sitting at PD 1 320 sees a video image of themselves 326 as well as the moderator 334. In addition to seeing video images of the moderator 334 or the participants themselves 326,328, and 332, each market research participant views the stimulus 336 (on another web page). The stimulus 336 is the product or service the sponsoring company is evaluating. In addition, each market research participant has a text box 338 in which participants can submit participant responses to the moderator. Depending on the sponsoring client's motivation, participant user devices may also include the capability of viewing other participant images and submitted responses.

Returning now to the moderator's web browser 380, the moderator sees each video image of each market research participant 326, 328, and 332, a video image of the moderator themselves 334, as well as the stimulus 336. From the sponsoring client's web browser 380, the sponsoring client views the entire virtual communication facility: each market research participant 326, 328, and 332, the moderator 334, the text boxes or submitted responses 338 and the tested stimulus 336.

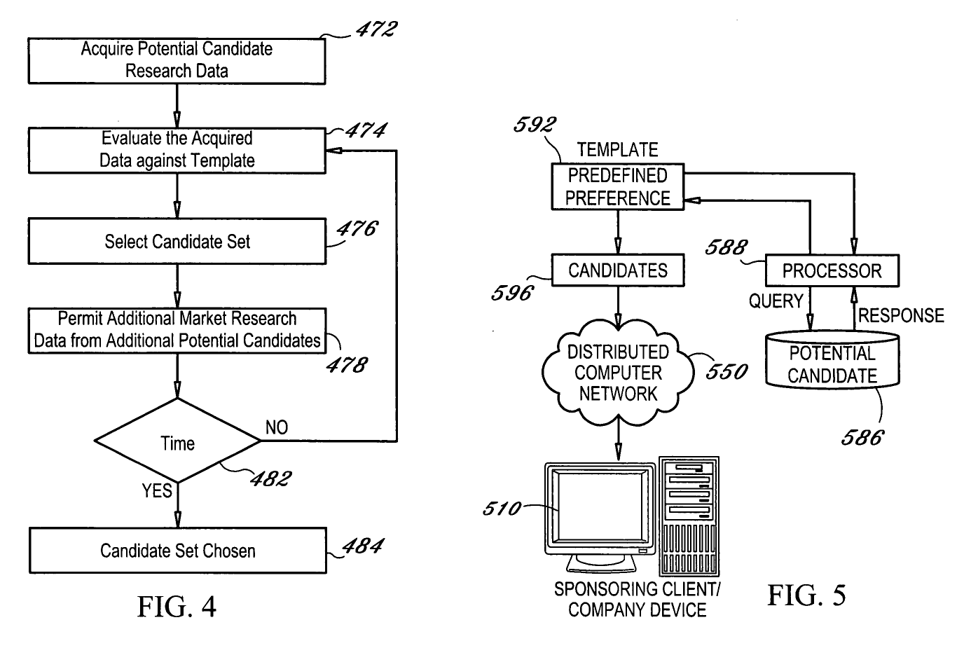

FIG. 4 represents an exemplary flow diagram depicting the process involved when dynamically selecting a set of candidates. First, in step 472 market research data is acquired on a potential candidate set. This market research data is namely demographic information on the potential candidates. At step 472, the potential candidate universe is as expansive as there are people with distributed computer network access. The potential candidate universe represents the world. Then at step 474, the world or the potential candidate universe is evaluated and narrowed. Demographic data submitted by the potential candidate is evaluated in step 474 against a template often provided by the sponsoring client. This template represents to the sponsoring client an ideal market research participant pool at any given time. Once the potential candidate pool has been evaluated in step 474, then in step 476 a candidate set is selected; The candidate set selected in step 476 represents a set of candidates fewer than the potential candidate set. This candidate set has been selected to fit the template in accordance with a predefined preference supplied by the sponsoring company. Next in step 478, additional market research data about other potential candidates is considered in determining the candidate set. This process of evaluating and selecting candidates continues until a time certain. In this way, at any given time, the candidate set will resemble a most ideal market research participant pool. If the sponsoring client determines that that time has been met in step 482, then the candidate set is chosen, information disseminated, and the process ends at step 484. However, until that time comes, the present embodiment will continue acquiring, selecting, and permitting additional market research data such that an optimal candidate set at any given time is chosen.

FIG. 5 represents an exemplary network arrangement for dynamically choosing a market research group in accordance with one embodiment of the present invention. As can be seen in FIG. 5, the process for dynamically choosing a market research group is conducted over a distributed computer network 550. The system alerts the sponsoring client 510 of candidates who meet the sponsoring client's prescribed research directive through the distributed computer network.

In essence, the acquired market research data of potential candidates fills a potential candidate database 586. This database 586 can be either a general population sample database or a proprietary corporate/membership database. A processor 588 communicates with both the potential candidate database 586 and a template 592 populated with a predefined preference of potential candidates. Ultimately the processor 588 evaluates the acquired market research data from the potential candidate database 586 in light of the template 592 and selects a set of candidates 596. This candidate 596 set may then be sent over the distributed computer network to the sponsoring client 510 for review.

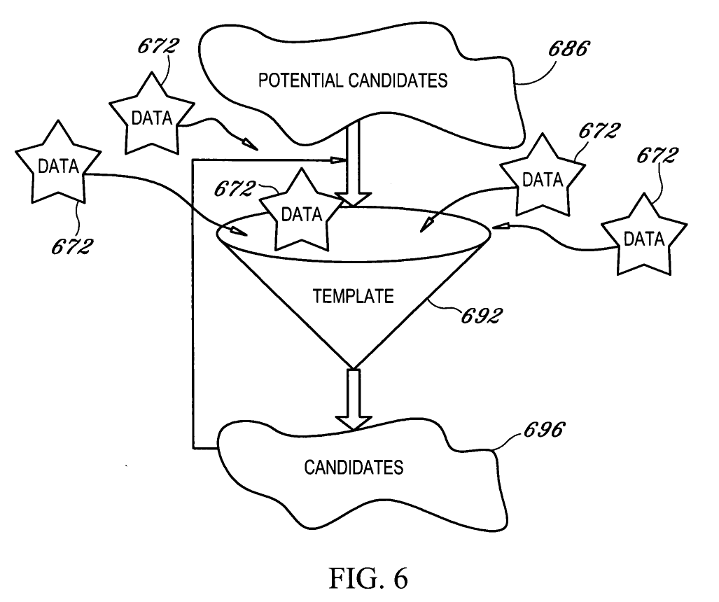

FIG. 6 represents an exemplary template system for dynamically modifying a template to select a set of candidates in accordance with another embodiment of the present invention. Besides acting as a virtual market research study facilitator, and a potential candidate selector, the present invention also acts as a repository of market research information. Sponsoring clients can use the system as a source of study. The potential candidate universe 686 depicted in FIG. 6 comprises of both potential candidates stored in the memory of the potential candidate database 586 as well as potential candidates continually received across the distributed computer network. The candidates in the potential candidate universe 686 are then evaluated through a modifiable template 692 defined by the sponsoring client. The modifiable template 692 specifies the kind of information that the sponsoring client wishes to receive from the potential candidates in the potential candidate universe 686. Once the potential candidates have been evaluated by the modifiable template 692, a set of candidates fewer than the set of potential candidates are selected in accordance with the template 692. Sponsoring clients can further modify the template 692 with additional template data 672. The potential candidates in the potential candidate universe 686 are then evaluated against the modified template 692, resulting in a dynamically selected set of candidates 696 at any given time. In this manner, sponsoring clients utilize the system as a disseminator of market research data and not just as a facilitator of acquiring market research data and candidates.

The present invention allows users (i.e. clients, participants, moderators, etc.) to experience live video and audio input from participants in the comfort of their own homes, offices or anywhere. Clients can observe or view in real time the ongoing research or other activity being conducted between one or more participants and the moderator(s). The use of the present invention system will be described in connection with market research. However, such use should not be considered limiting and it should be recognized that the various other uses for the present invention are possible and all are considered within the scope of the invention.

The real time client viewing capability will be referred to or defined as the “backroom”. The location of the client can be anywhere they desire, such as, but not limited to, office, home, vacation location, etc. None of the parties to the market research (moderator(s), participant(s), client(s), etc.) are required to be in the same room or even the same geographical location. The present invention allows traditional market research standards to be replicated over the Internet, and also permits new research opportunities where client(s) and moderator(s) can be able to capture and record subtle nuances and reactions of participants in ways not believed previously possible.

The present invention system allows for one way or two-way audio and video communications between research respondents or participants and market research professionals (moderators, interrogators, etc.) through a common platform such as, but not limited to, Microsoft operating systems and software. However, other platforms and operating systems can be used and are considered within the scope of the invention.

Preferably using a broadband or high speed connection, a research environment is created by the present invention system where participants, moderators and clients meet on-line for audio/video conferences, without travel requirements for anyone participating at the meeting. The present invention system uses a known videoconferencing software platform in connection uniquely designed web-based application add-ons. The present invention can be based on a plurality of modules, with some modules enhancing the web application for using the system and other modules provide interlinking components for web applications. The modules permit for the sharing of stimuli in graphic, text and/or video formats, which are commonly used in market research studies.

The present invention allows for sharing and/or streaming of a video focus group session to a passive viewer (i.e. client observer(s)) located in the Backroom of the system. One or more, though preferably one, designated observer is permitted to communicate with the moderator (i.e. interviewer, interrogator, etc.) while the session (which can be one or more participants) is ongoing and without the participants knowing. Other non-designated clients can be permitted to review the session in real time and also be permitted to communicate with each other while the session is ongoing. However, it is preferred, though not considered limiting, to reduce the number of client individuals who can communicate with the moderator while the session is happening. Thus, the present invention provides for virtual electronic “note passing” between the designated client individual and the session moderator while the session is in place, which permits the moderator to ask a question to the participant(s) that has been received by the moderator from the client.

A second part of the Backroom aspect of the invention is the passive client viewer interface. As mentioned above, the non-designated passive clients can communicate amongst themselves and to the designated client individual (another form of virtual note passing). Thus, if the designated client individual believes that a comment or question (collectively referred to as “message”) from a passive client viewer (non-designated) should be sent to the moderator, the designated client can either forward the message directly to the moderator or retype or paraphrase the message and then send it to the moderator. The passive viewing clients can then know when their question is given to the moderator so that they can be alert in order to see and hear the response from the participant(s) to their question. Accordingly, other then not having direct access to the moderator during the session, the passive client viewers can see and hear all aspects of the communication system of the present invention in real time as it is occurring. Live streams (video streams) of all of the participants for the session are sent to the Backroom. The Backroom can be a password protected web-based web site which can be accessible by the client(s) via a secure password.

Furthermore, in one non-limiting embodiment, after a session has been concluded the system can be programmed or otherwise setup to permit communication between the moderator and all of the clients (designated and non-designated). In other words, the system can include a blocking feature, which is automatically or manually activated, to prevent non-designated client(s) from having access to the moderator, whenever the moderator is conducting a research session or otherwise questioning participants.

The present invention system can be used in many different languages and is not limited to any particular language. When conducted in non-English languages, the present invention system can be provided with live Voice of IP (“VoIP”) capabilities to the Backroom viewer to allow them to hear live translated voice of the Session. VoIP is considered any technology providing voice telephony services over IP connections. The feature may be particularly useful where the client is English speaking and the research is in one or more foreign countries or in the United States in a non-English language. Once the research session has ended or concluded, the moderator can remain in the focus group and instruct the client(s) in the Backroom to start the VoIP application to permit an immediate live debriefing/interactive conference call between the viewing client(s) and the moderator (interviewer, interrogator, etc.). Thus, the present invention system provides for instant real time debriefing and eliminates the need for a third party conference line.

As mentioned above, the present invention system can be designed for various operating systems and web browsers. However, in one non-limiting embodiment, the system used a Microsoft Windows operating system and a Microsoft Internet Explorer 5.5 or higher version browser. The present invention system can interface with various videoconferencing platforms, such as, but not limited to, the platform offered by Polycom Systems. Other operating systems for the present invention include but are not limited to Macintosh, Linux, Sun Solaris, etc.

In one non-limiting server side embodiment, a videoconferencing software platform is used in connection with a Windows 2003 or Windows 2000 server and a IIS 6 web server. In one non-limiting participant side, a small application (i.e. web endpoint) can be installed on each participant's and/or client's computer to permit the participants and/or clients to connect to the system servers. The application software can be installed via a web link, CD-Rom, floppy disk, etc. The web endpoint invokes the participant's web browser (i.e. Internet Explorer, etc.) and connects the participant to the system server. The client connection can verify that the participant and/or client is a verified user permitted to connect to the system server. For added security, a secondary password can also be used in order to join the research event.

The web endpoint client can be compatible with a variety of operating systems, such as, but not limited to, Windows 2000 Professional, Windows XP Home Edition, Windows XP Professional Edition, etc. A conference client can be supported by a variety of web browsers, such as, but not limited to, Internet Explorer 5.5 and later versions, etc. A conference client can run on a variety of computer configurations, such as, but not limited to, CPU Pentium III 800 MHz or higher, RAM 128M or higher, 16 bit full duplex sound card and network card NIC card for broadband. Other configurations can be used and are considered within the scope of the invention.

Though not necessary tied to any particular Module order or number, for purposes of describing the present invention system, Module 1 can be associated with the moderator entry web endpoint. Though not limiting, this module can be based on Windows 2003 server or Windows 2000 server. Module 1 includes a Moderator Remote Viewer (MRV) which allows “note passing” between the moderator and one or more of the client(s) in the Backroom. The note passing can be performed entirely from the moderator's conference web screen. To facilitate the note passing capabilities, duplication and renaming of an existing folder within the framework of the server application can be performed in order for add-on code can be added.

Preferably the server where the server application is installed and setup is accessed and the existing file folder is copied or duplicated. The file folder can be located on the server under a specified path. Once located, the folder is copied by conventional means (i.e. right mouse click and copy selected, etc.). Once copying is finished, the folder can be pasted into the same directory. With the server services preferably stopped on the server, the server Admin control panel “services” can be accessed. The duplicated file folder can be renamed to any desired name by conventional means (i.e. right mouse click and rename selected, etc.). Once the copied file has been renamed, the server services can then be restarted from the Admin control panel. Once restarted, preparation for the note passing add-on can be considered completed.

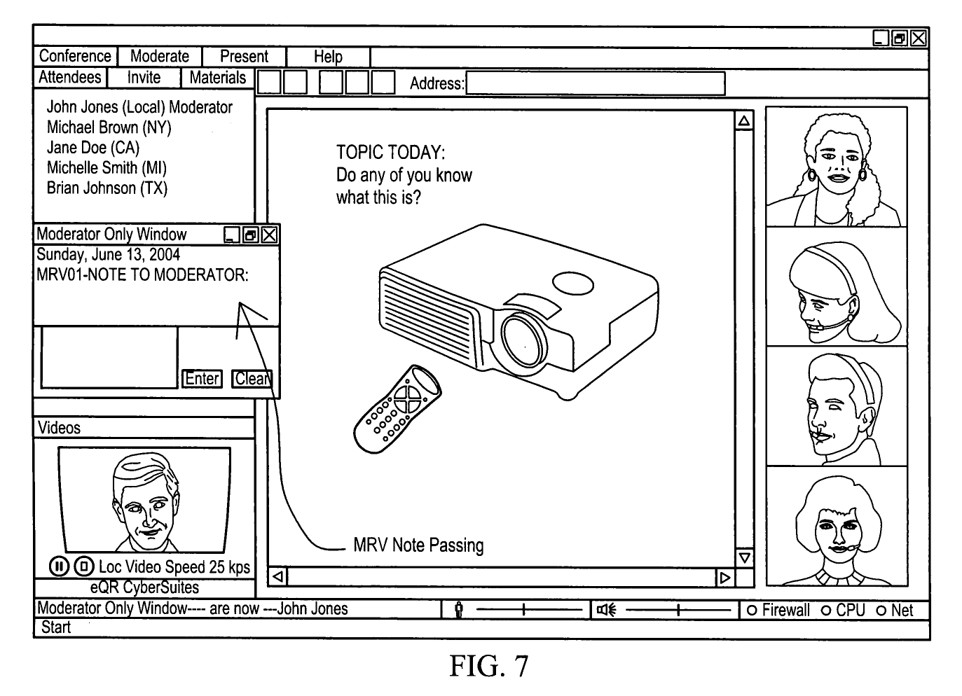

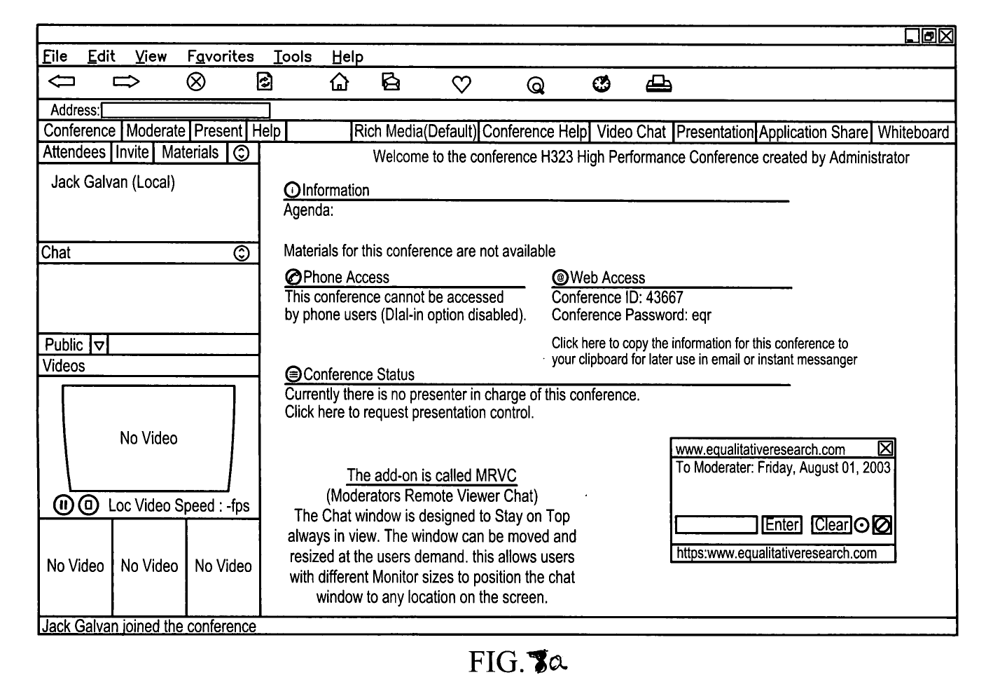

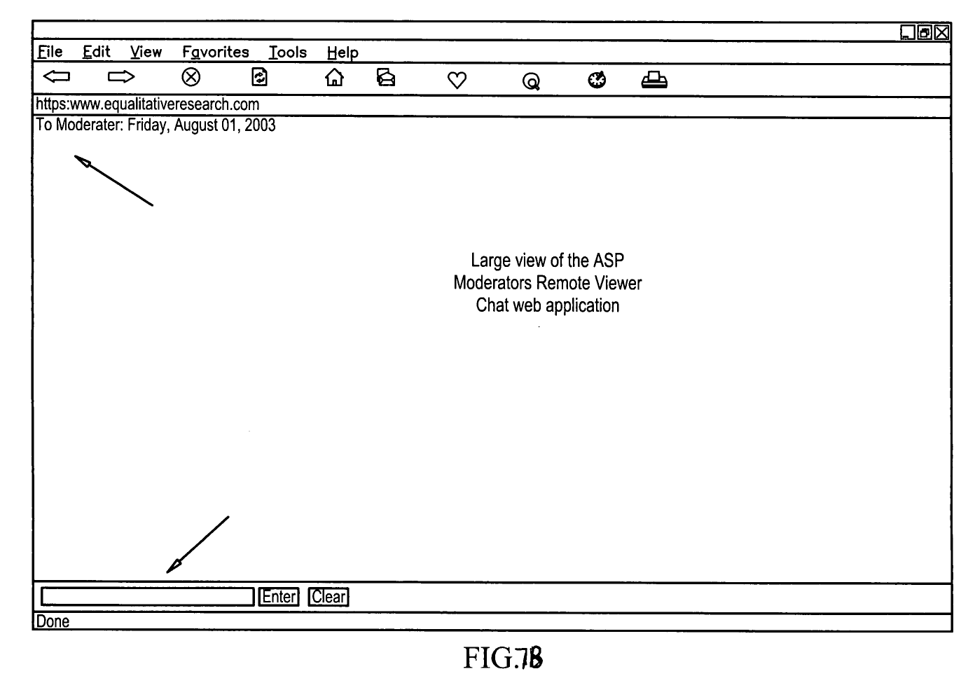

The note passing add-on preferably employs the services of a web server for proper functioning when called upon during a session. In one non-limiting embodiment, an IIS 6 web server, utilizing Java and ASP scripting can be used to facilitate the note passing application. A web folder can be created on the web server to permit the note-passing application to access the add-on script. The web folder can contain an interactive web application that can transmit typed notes from the client and/or the moderator. The present invention system instructs the web server to facilitate the add-on script code. Linking of the web server and the add-on script code is provided for functionality and usability. As described below, the correct path is used within the add-on code installation. As seen in FIG. 7, a screen shot is shown displaying the MRV activated and in action during a research session. FIG. 7a also illustrates the moderators' chat window on a screen, while FIG. 7b illustrates a larger view of the ASP moderators remote viewer chat web application.

A further add-on under this Module concerns added HTML code to an existing webpage within the newly namely folder. Preferably, using an HTML editor program, the HTML code of the videoconference can be accessed. The web page chosen to be edited can be where the add-on code has been inserted. Though not limiting, a script code could be similar to the one shown below:

<script>
function modelesswin(url,mwidth,mheight)
if (document.all&&window.print) //if ie5
eval(‘window.showModelessDialog(url,””,”help:0;resizable:1;dialogWidt
h:’+mwidth+’px;dialogHeight:’_mheight+’px”)”)
else
eval(‘window.open(url,””,”width=’+mwidth+’px,height=’+mheight+’px,r
esizable=1,scrollbars=1”)’)
}
//configure URL and window dimensions (width/height)
Modelesswin(http://www.xxx.com/filename/filename.htm,400,300)
//To load via link, use something like below:
//<a
Href=”javascript:modelesswin(‘http://www.xxx.com/filename/filename.ht
m’,415,315)”>Click here</a>
</script/>

This code can call upon the IIS webserver referenced above to invoke the MRV note passing script. The moderator can begin by opening a website, which can be referred to or called mrv01. This website can be associated with a specific research session. When activated, the moderator can be locked into the mrv01 add-on script code. As seen, code can be written to permit the chat window to always remain on top of the website pages, so that it is viewable to the moderator during the research session. The chat window can be moved and resized at the user's demand. This allows users with different monitor sizes to position the chat window to any location on the screen.

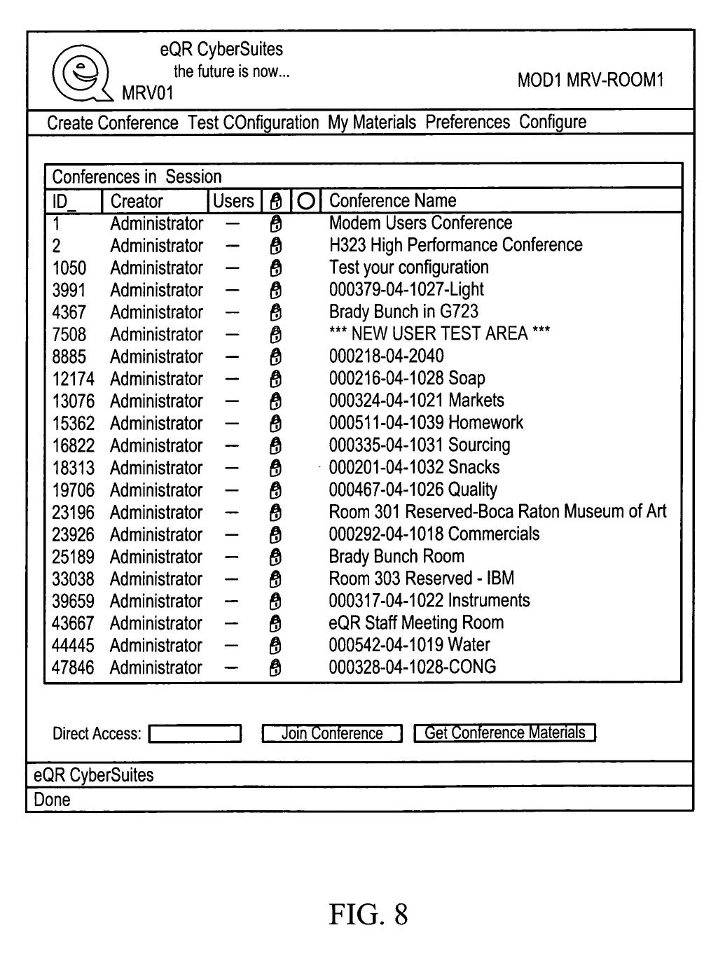

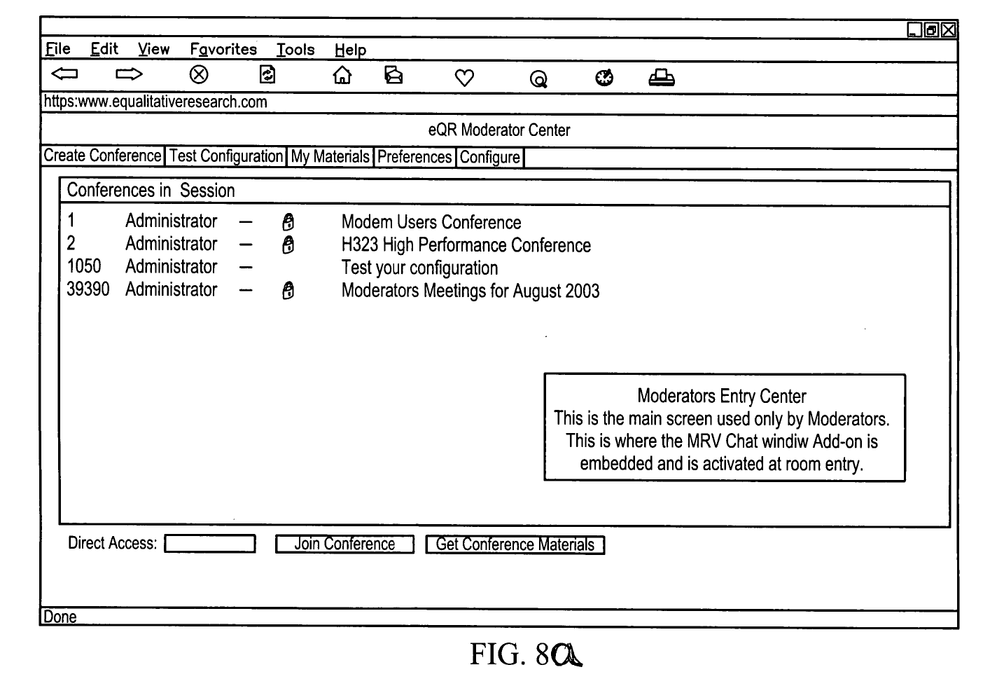

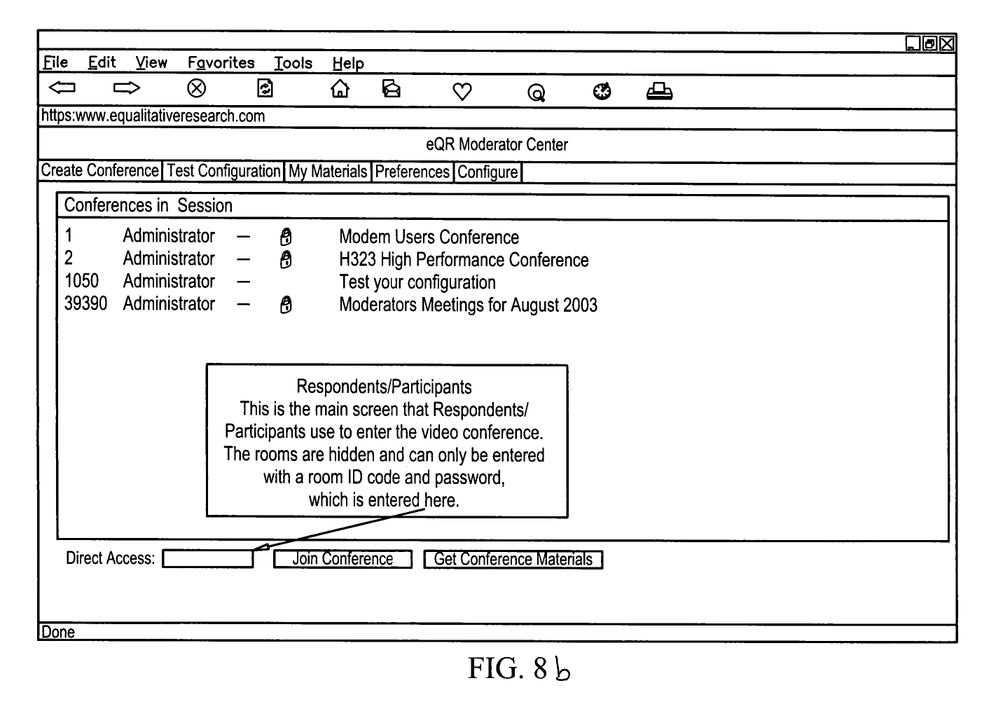

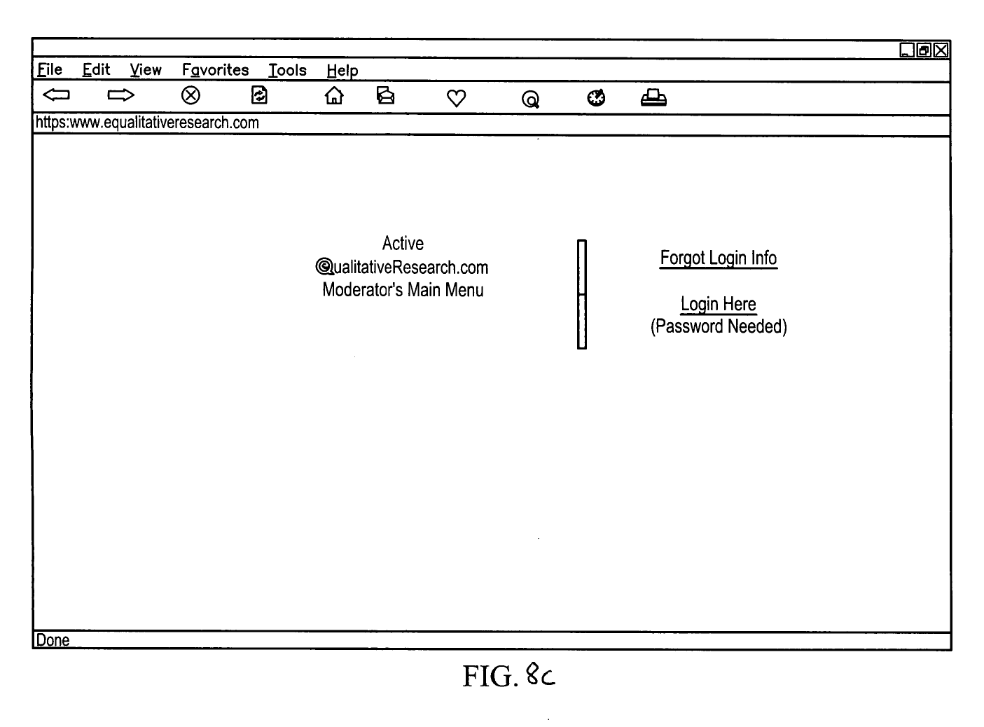

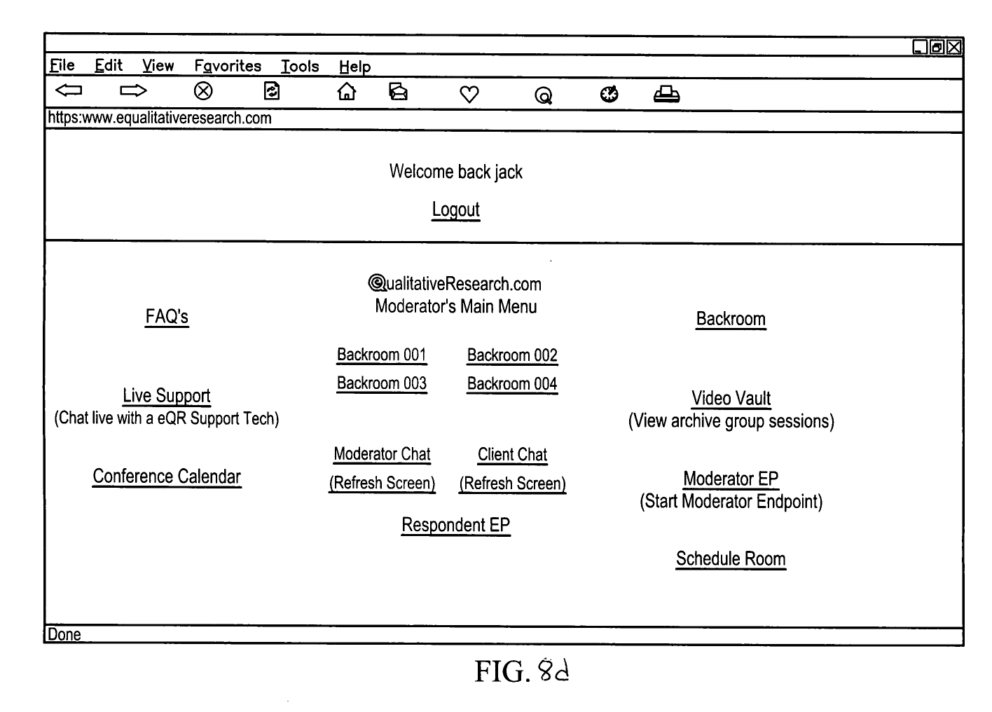

In order to facilitate multiple research events at one time on the same server using the above described add-on script, the file folder should be duplicated for each event as described above. Non-limiting working examples can include mrv01, mrv02, mrev03, etc. One limitation to the number of duplications can be the amount of hard drive space available on the server. BY creating multiple moderator rooms (mrv01, mrv02, etc.), multiple simultaneous research events can be conducted at the same time on the server. As referenced above, web server folders can be created to correspond to the moderator rooms. For example, MRV01 on the server can link to and tie into the web server with a folder named mrv01 preferably with the note passing scripting embedded into the code. For moderator entry or access to a website listing of the research events, the web browser can be opened and accessed in the following format: http://xxx.xxx.xxx./index.htm. The website associated with the URL will start and though not limiting, can look similar to the screen shot shown in FIG. 8, which identifies all of the research events contained on the server.

FIGS. 8 and 8a illustrate embodiments for a moderator focus group room entry. The chat window with the Client can be embedded and can be activated at room entry. FIG. 8b illustrates an embodiment for the main screen for use by respondents/participants to enter a video conference. The rooms can be hidden and entered only with a room ID code and/or password, which is entered as shown in FIG. 8b. FIGS. 8c and 8d also illustrate other Moderator web screens,

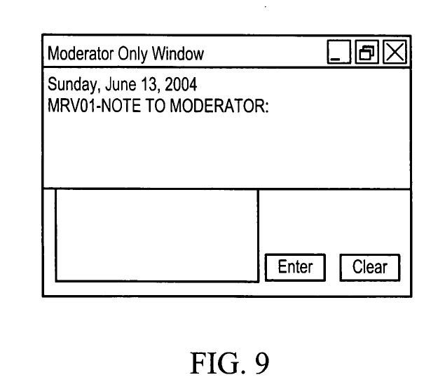

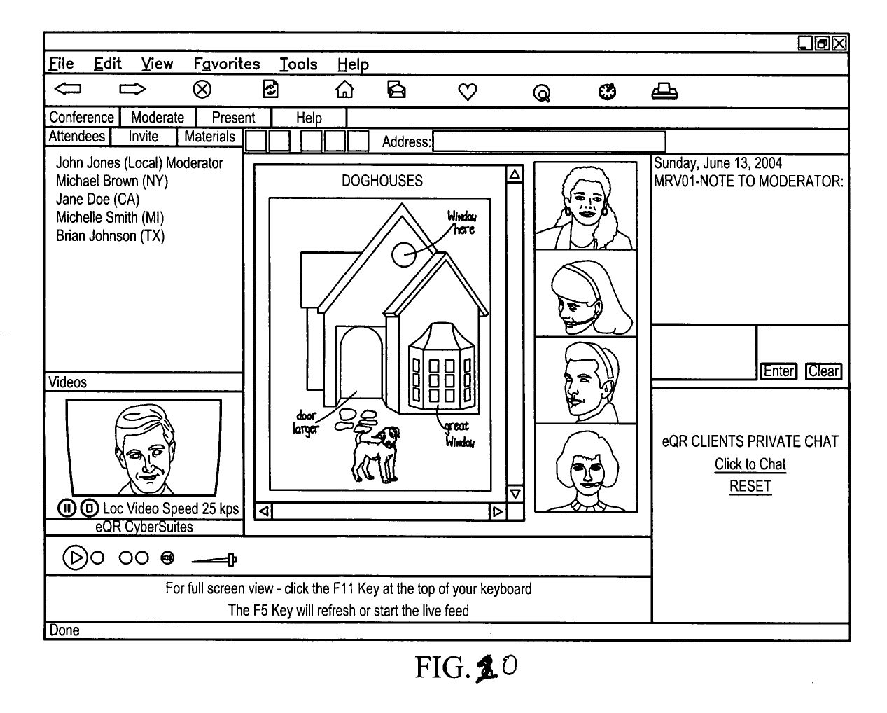

Module-2 can be associated with note passing add on which can allow two-way note passing and/or other communication between the designated client in the Backroom and the moderator/interviewer conducting a research session. FIG. 9 illustrates one non-limiting view or display of the note or other communication as seen by the moderator/interviewer on the screen. The moderator view of the MRV, such as that shown in FIG. 9, can interlink with the web server and the videoconferencing server.

In one embodiment, only the designated client can communicate and “pass notes” back and forth with the moderator/interviewer. This preferred, but not limiting, embodiment prevents the moderator from being distracted or bombarded with multiple notes from several clients viewing the session in the Backroom. This preferred embodiment can create two separate Backrooms, one for the designated client and one for the passive viewing client. In one embodiment, the passive viewer client (non-designated) is permitted to view the notes or other communications as they are passed to the moderator by the designated client. The passive viewer client can also be permitted to view any notes or other communications sent by the moderator to the designated client.

Module 3 can be associated with the Backroom used for the designated client and one version of the screen display (web page) is shown in FIG. 10. As mentioned above, the Backroom can be separated into two parts: (1) Designated Client Backroom and (2) Passive Non-Designated Client Viewer Backroom. These two Backrooms can work in consort or concert with each other to create a unique and novel experience for the clients. The Designated Client Backroom can be a website on the systems web server that links to or otherwise in communication with the moderator's entry. Using the MRV naming convention example discussed above, each Backroom can be linked to or otherwise in communication with a corresponding Moderator MRV room.

Live video and audio stream of the research session to the Backroom can be provided and can be based on existing technology, such as, but not limited to, Microsoft Windows Media Streaming Server. The web page can be in an HTML frames format within a plurality of frames, such as, but not limited to three frames. The top right box in FIG. 10 illustrates the MRV note passing module in action. The bottom right area can be designated for the clients private chat area. Clients can chat with each other in real time during the research session. Thus, while the session is in process, the clients can exchange ideas and formulate questions or modifications for subsequent sessions or events, or to provide to the designated client for sending to the moderator during the ongoing session.

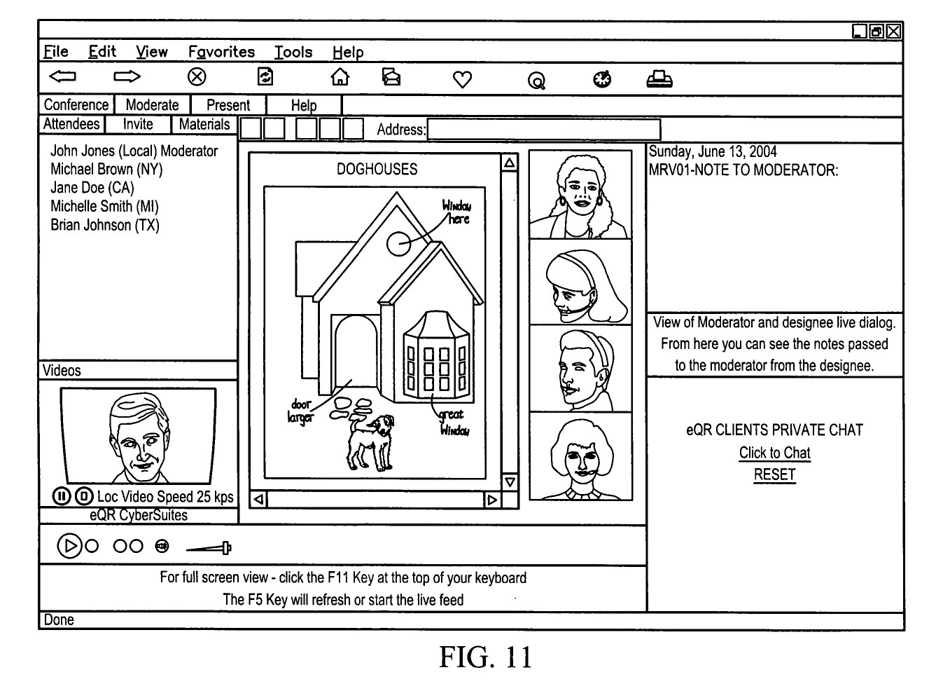

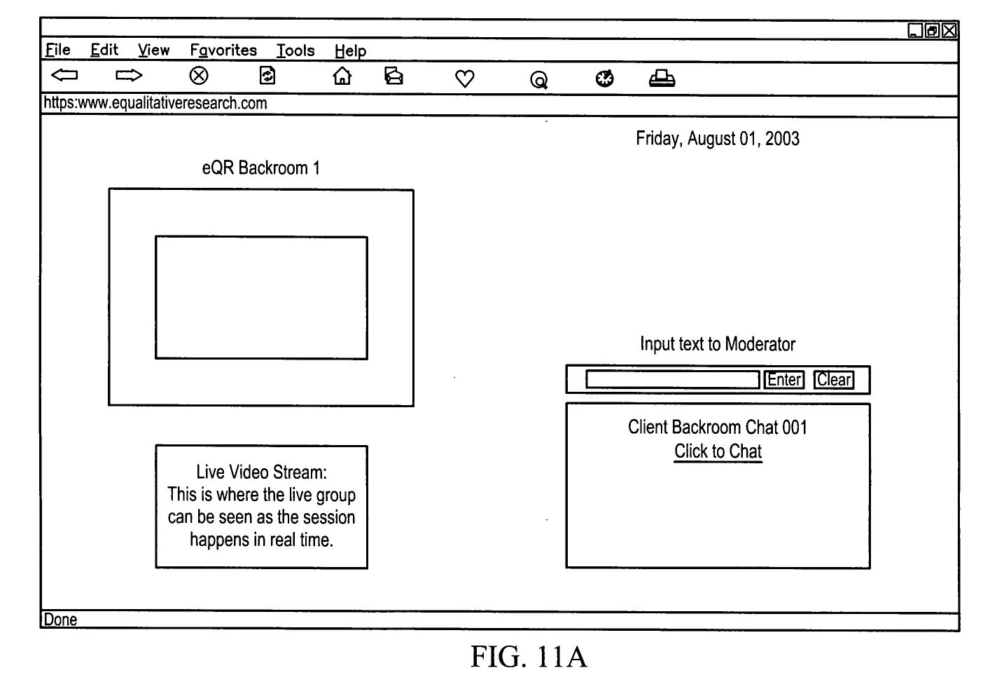

Module 4 can be associated with the passive viewer (non-designated) client Backroom and one version of the web page (screen) is shown in FIG. 11. This web page can be similar to the Designated client web page discussed above, particularly when designed in a HTML frames page design. The web page differs, where in the preferred embodiment note passing available is not present. The passive viewer can be permitted to see the actual notes and/or communication being passed between the moderator and Designated client. This allows all clients in the Backroom to see and hear all activity taking place in the session. In one non-limiting web page design, the upper right area of the web page can be used for showing notes being passed between the moderator and Designated client. FIG. 11a illustrates another Backroom screenshot showing three separate applications running simultaneously.

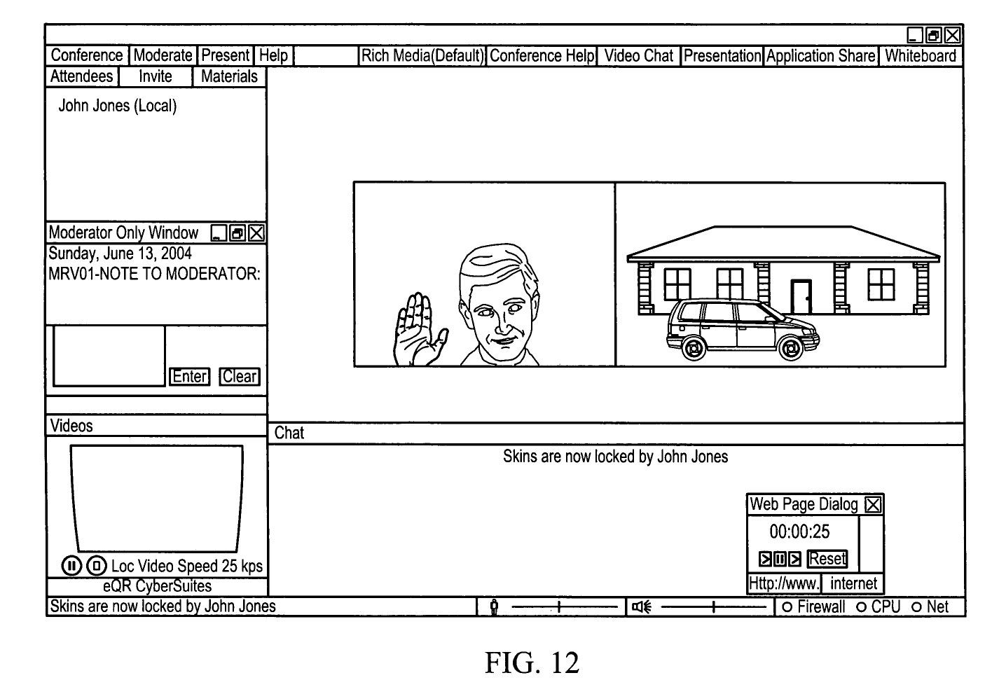

Module 5 can be associated with the live video stimuli side by side feature of the present invention system. As seen in FIG. 12, this part of the system can stream live video and/or audio content of choice (feed) directly into a research event and can be displayed next to the participants' video picture(s). Other locations on the web page are also within the scope of the invention. The participant(s) are able to see and/or hear the live video content and stimuli, as it is being displayed in real time. The side-by-side live video feed can be accomplished using various video hardware devices. In one non-limiting embodiment, a DVD player having a built-in VCR and TV Tuner can be used. In another embodiment the VCR and/or TV Tuner may not built in with the DVD player. Other conventional video and/or audio hardware configurations can be used and are considered within the scope of the invention.

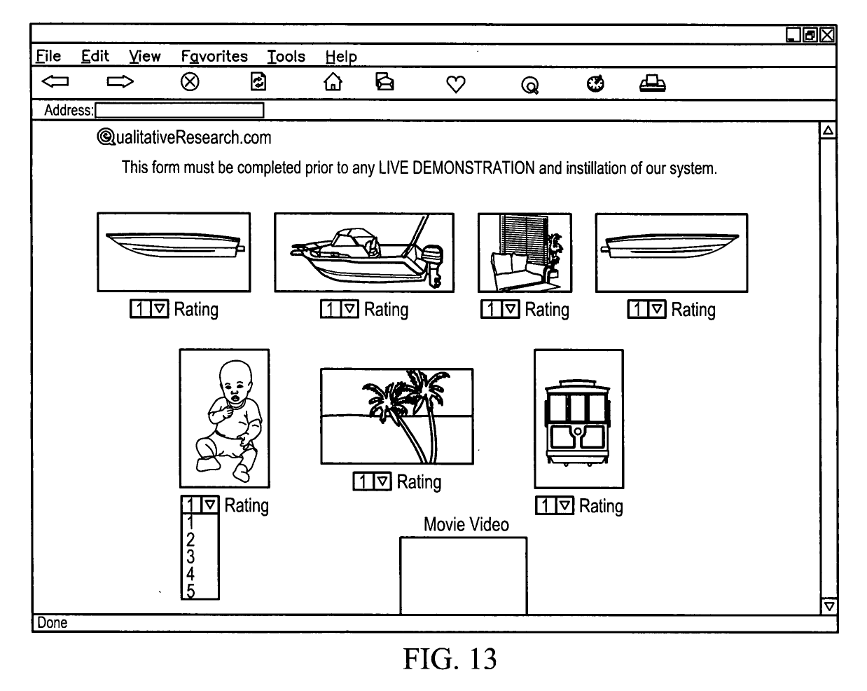

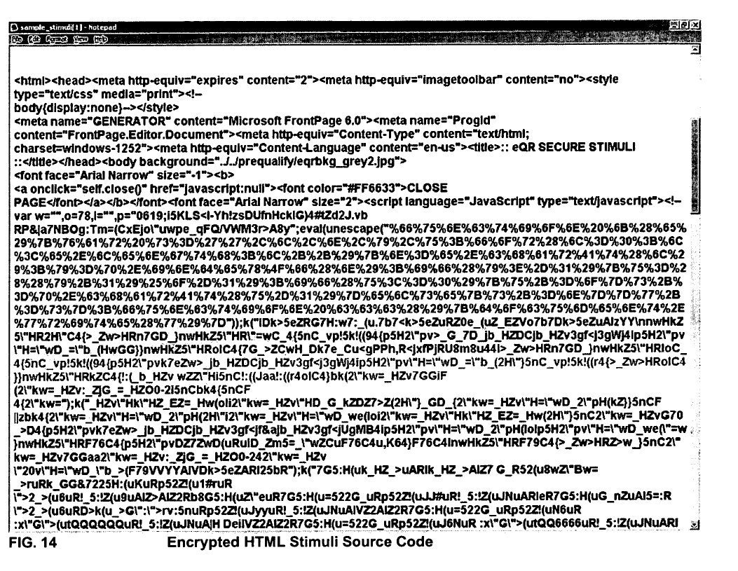

Module 6 can be associated with a HTML encrypted stimuli. The client's stimuli, product, advertising materials, documents, and/or videos, etc. may need to be shown to the participant(s) during a session, such as, but not limited to, a market research study. The present invention system can provide an encrypted method to secure the client's materials during a session. The method creates an HTML webpage of the material and encrypts the webpage with a software application, such as, but not limited to, HTML encryption software. FIG. 13 illustrates an encrypted web page that is shown to the participants during a focus group session being conducted by the present invention system. FIG. 14 shows the HTML source code for a web page encrypted when viewed as discussed above. The encryption of the HTML source code for the web page allows the present invention system to protect client's work products and proprietary art and other materials.

Preferably, the participant views the encrypted web page (i.e. as in the web page of FIG. 13) through a JAVA enabled web browser. However, other web browsers which will permit the participant to view the encrypted web page (FIG. 13) can also be used and are considered within the scope of the invention. Other non-encrypted methods, which will also protect the web page(s) can also be used and are also considered within the scope of the invention. The present invention system, which can be through direction of the moderator, can present the protected web page directly into the research session for viewing. Any polls, surveys, and/or other questions, etc. can be incorporated into the protected web pages for completion by the participant(s). The results of a completed survey can be virtually instantaneous and can be recorded into the web server of the present invention system. An email response can be sent by the system to a list of clients as the surveys or other answers to questions are completed. The system can also permit clients to receive an email from each or designated participant(s) upon completion.

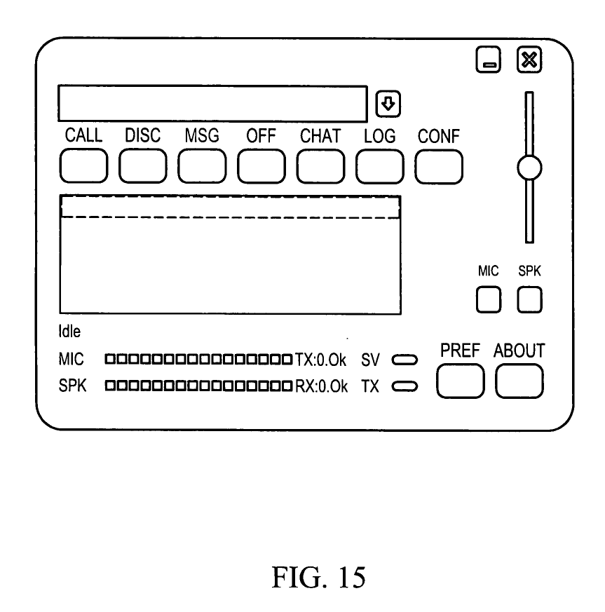

Module 7 can be associated an IP phone for the present invention system. The IP phone provides another effective way for communicating with the client(s) in the Backroom. In the traditional model, a long distance conference call using standard telephone lines is used to conduct a debriefing with all clients after a research project has concluded. The present invention can use the same broadband Internet connection that streams the Backroom video and audio feed to the clients. In the preferred embodiment, the IP phone of the present invention system can use VoIP technology (See FIG. 15).

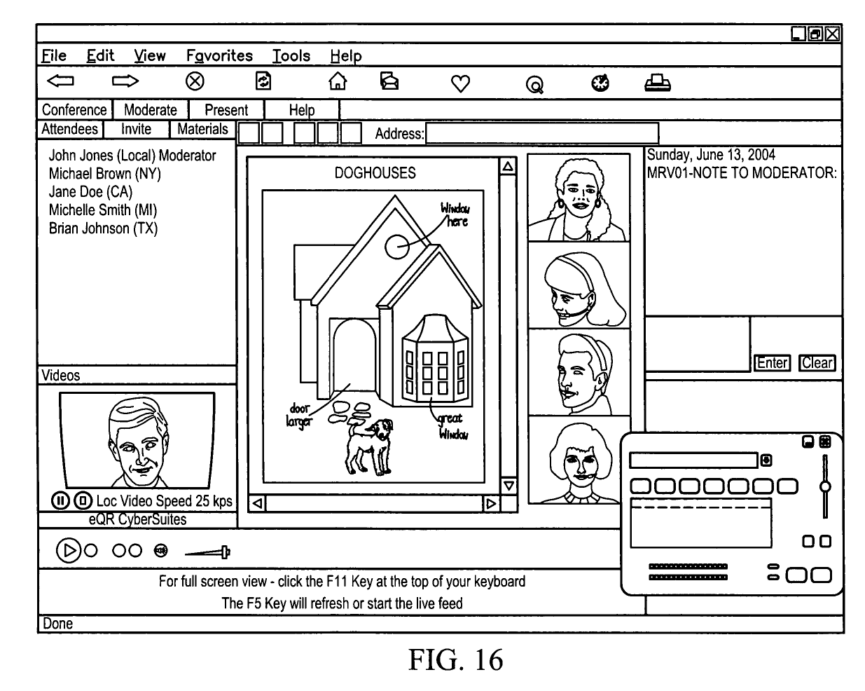

The IP Phone can use a simple UDP-based protocol, which works with NAT. The program can accept connections on UDP port 11676 and can make connection to that port. Alternatively, a port number can follow the address (with the colon used as a separator), if the connection has to be made to another port (the NAT router on the receiving side can convert the port number to the default 11676). The IP phone can allow multiple concurrent calls and the audio device can allow multiple output streams to be opened virtually simultaneously. The screenshot shown in FIG. 16 illustrates the IP phone of the present invention system activated and running with the client Backroom. The clients can speak with the moderator through a standard PC microphone and headset. To ensure proper function of the IP Phone, a sound card with full duplex capabilities and microphone input can be provided and a network card (NIC) can also be provided for a broadband connection.

FIG. 16 can also illustrates Module 8 which can be associated with the present invention system's annotation capabilities for any type of stimuli. The system provides an effective way of permitting the participants to “mark up” the stimuli. Each respondent (participant) and moderator can be provided with a pen to mark up the stimulus shown on the screen. Though, not considered limiting, each individual (participants, moderator, etc.) can have a different color pen in order to identify each mark up to the individual who created the mark up. The marked up stimuli can be recorded and stored for later viewing and detailed analysis. File sharing and white boarding capabilities can also be provided by the present invention system.

Module 9 can be associated with a DVD record and capture capability of the present invention system. Other hardware for recording and/or capturing the session can also be used and are considered within the scope of the invention. If desired, the present invention system can record every session, focus group, individual study, etc. for every client. Preferably, the recordings can be prepared and recorded as the session or study is in progress.

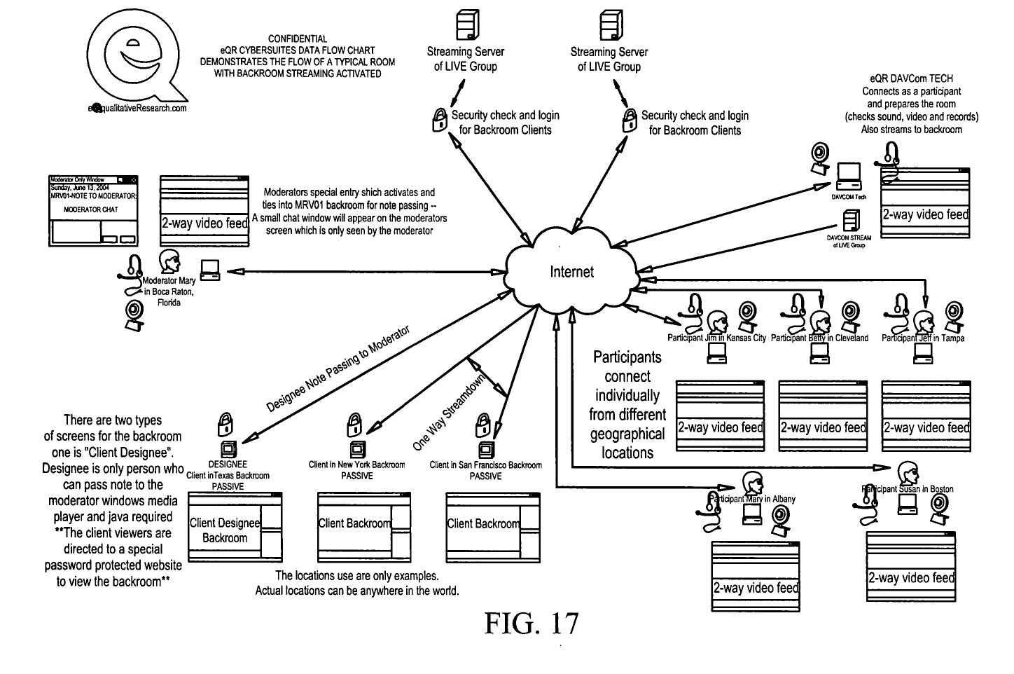

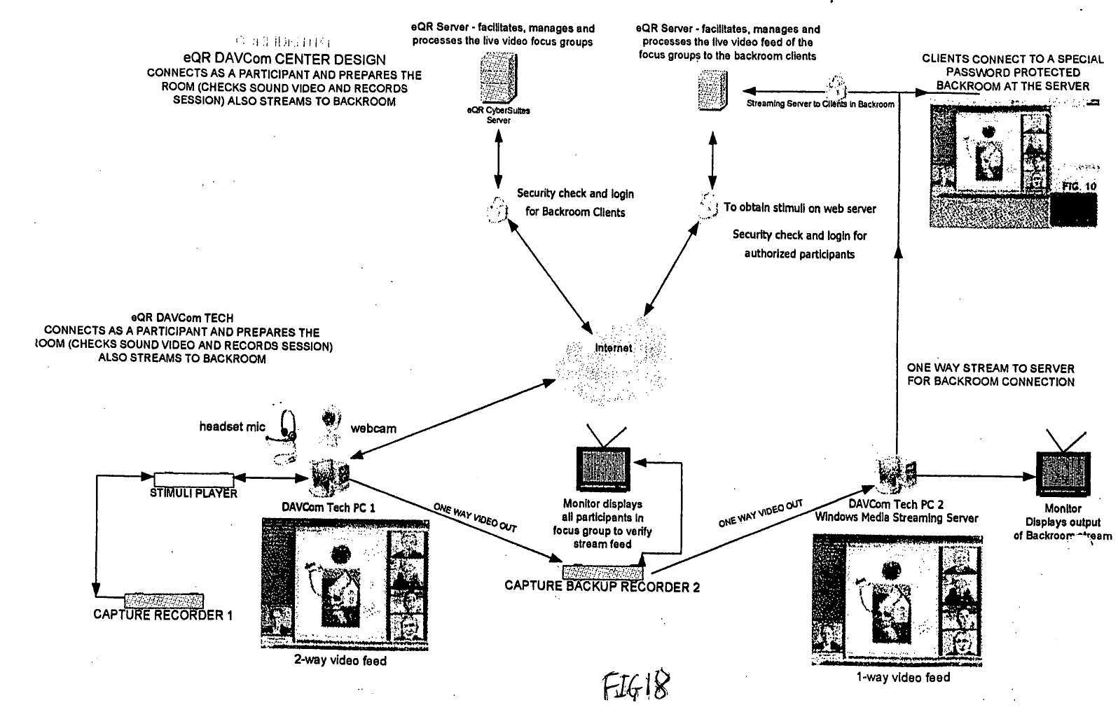

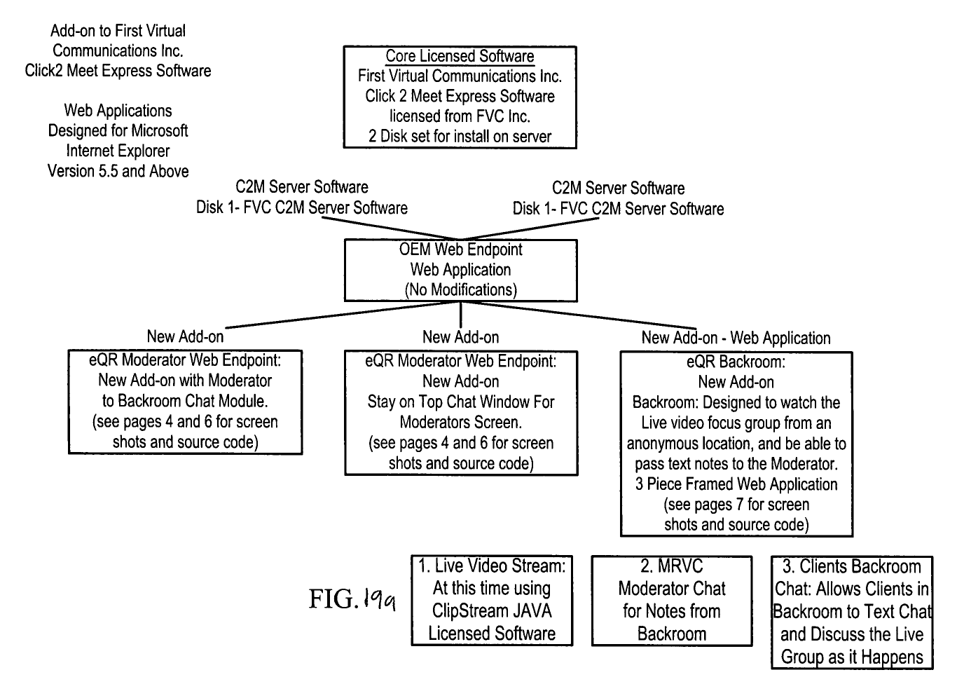

The present invention system, including, but not limited to, the above-described modules can be managed and deployed through a digital audio and video computer (“DAVCom”) tech center (“Center”). One non-limiting configuration for the Center is shown in FIG. 17. Through use of the Center all components and modules can be brought together in one centralized location. A computer technician can be assigned to each session to manage, monitor, troubleshoot and/or deliver the specified client stimuli or client content on demand or request of the moderator. The technician can also be responsible for overseeing the video recording of the session.

Thus, in the preferred embodiment, the present invention provides an Internet based focus group video meeting web application, which can work within a Microsoft Internet Explorer web browser and work with Microsoft operating systems. A virtual environment, where participants, moderator and clients can meet on-line using Broadband Internet connections for a focus group video meeting experience, without travel. The web application can be inspired by the traditional model of focus groups currently in use in a non virtual or electronic environment. Off the shelf servers and client software entitled Click To Meet Express can provide the foundation for the design of add-on web based applications, which can be designed to a variety of specifications, including, but not limited to, those for conducting focus group studies. The present invention application can share stimuli in graphic, text and/or video formats with application sharing capabilities with security at issue and incorporated into. The application can also share and/or stream a video focus group session to a passive viewer in the Backroom, who can communicate with the moderator of the focus group without the other participants knowing. The application can also stream live, the video streams of all participants to the Backroom web based Internet accessible by a secure password protected website. The application can also include live VoIP to Backroom viewers to hear live translated voice.

The client software is not limited to the Click to Meet Express program and other similar software programs can be used and are considered within the scope of the invention. The developer of the Click to Meet Express software that can be used as the base application is First Virtual Communications, Inc. (“FVR”). The use of the term Add-on can also refer to add-in, snap-in or plug-in to a existing web application and are designed to enhance or supplement an existing software application. The term eQR refers to a research company or another other organization or individual responsible for providing the services offered by the present invention system.

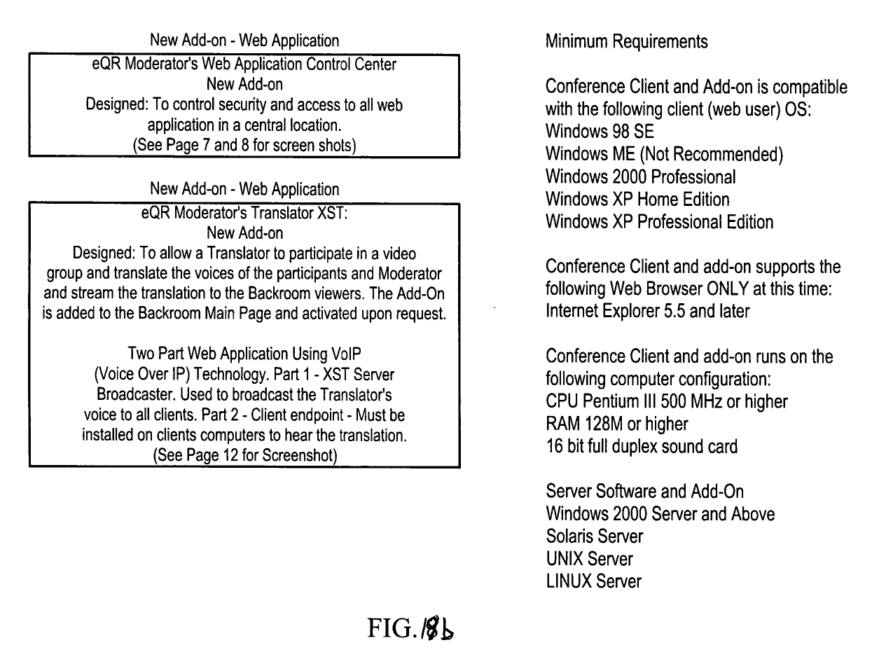

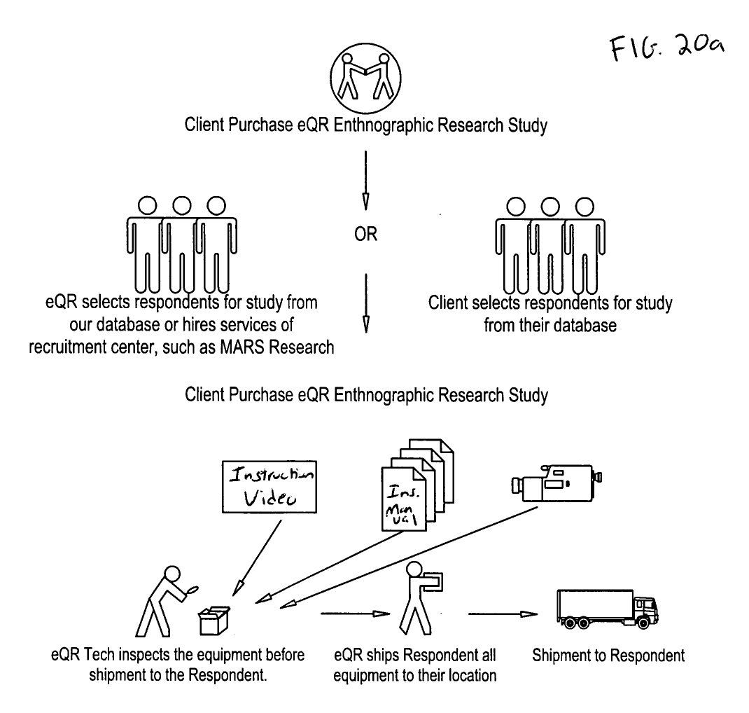

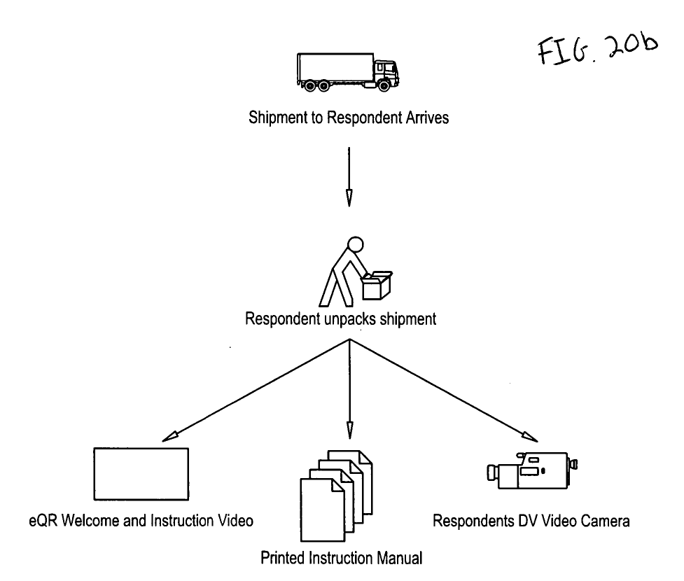

FIGS. 17 and 18 illustrate overall system configurations for embodiments of the present invention system. FIG. 19 illustrates a configuration of one particular hardware/software embodiment for the present invention system.

Ethnographic Research. The present invention also provides for a novel method for performing Ethnographic research. Traditional Ethnographic research, especially in the context of Market Research, is extremely costly, time-consuming and tedious to conduct. It involves having a highly skilled professional, typically a trained psychologist or sociologist go to the natural environment of the respondent, which could be their home, office or any environment that is in question to the sponsoring clients informational needs. The observations and interviews are usually several hours, and also involve a videographer who accompanies the interviewer. Given the requirements to conduct traditional Ethnographic research is it highly unusual, if not impossible, to conduct more than two such interviews in a day. Therefore these studies are typically conducted among fairly small samples. Each research sample takes several hours to complete and many hours to analyze. A detailed report is usually supplied to the sponsoring client at the end of the process.

The present invention provides a novel method for conducting Ethnographic research. The method of the present invention can involve communicating with the respondent and sending them the areas (e.g. room(s) of a house, rooms of an office, etc.) to record on the recording device such as a digital video camera with sufficient memory to record the requirements of the clients' research objectives. During the video capture experience, the respondent or participant can also narrate what they are showing (recording) and explain in detail all the thoughts and details which is recording into the capture device which has a built-in microphone. Once completed, the respondent can then send the camera and/or the memory chip (or other memory storage) back to the research company. Though not preferred, it is also within the scope of the invention for the respondent to send the recording by electronic means, such as over the Internet.

The audio and/or video content captured or recorded by the respondent can be streamed onto a web page, such as, but not limited to a secure, password protected web page on a virtual private network. The present invention system can be used for this purpose and the virtual private network and/or password protected web page can be similar to those described above for the present invention system. A lengthy in-depth interview with the respondent can then conducted by an interviewer as stated above which includes the stimuli (respondent's recording) as the reference point for the interview. The client(s) can observe these interviews from any internet-connected computer in real time. Further, the on-line interviews can also be recorded, using a device such as, but not limited to, a DVD recorder, for later viewing and archiving. The data can then be analyzed as in traditional ethnographic studies and a report can be issued to the sponsoring client.

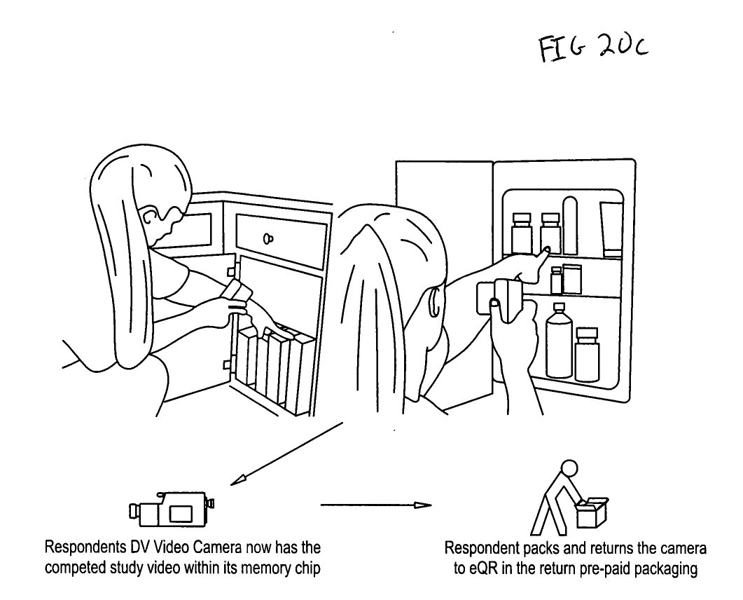

Without limitation, some of the benefits of the Ethnographic research method of the present invention include costs saving, efficiency, less “wear and tear” on the interviewers, broad geographic representation, with no travel for anyone involved, a more natural, non-intrusive process of having two strangers in the respondents environment for several hours yielding “purer” findings. Additionally, the interviews can be observed by as many viewers as desired on the sponsoring clients' side. Similar Backroom advantages can be provided as all of the interviewing capabilities of the present invention discussed above (i.e. communication between the observers, “note-passing” to the interviewer/moderator, etc.) are available. Traditional Ethnographic studies cannot be observed in real time (and therefore cannot be modified by the client in any way) unless the client actually accompanies the interviewer and the videographer, which is rarely done. FIGS. 20a-20e illustrates the various steps involved in one method for performing Ethnographic research in accordance with the present invention.

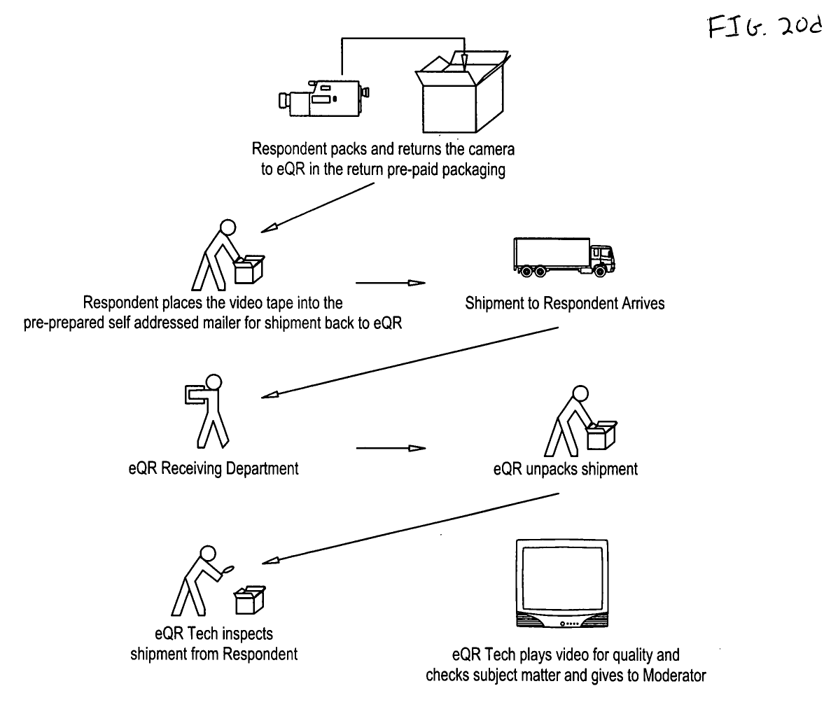

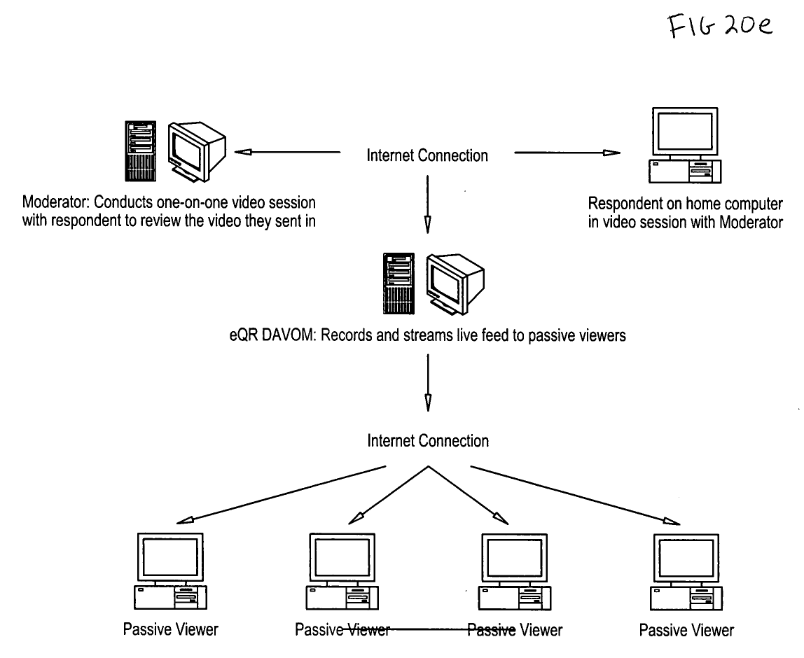

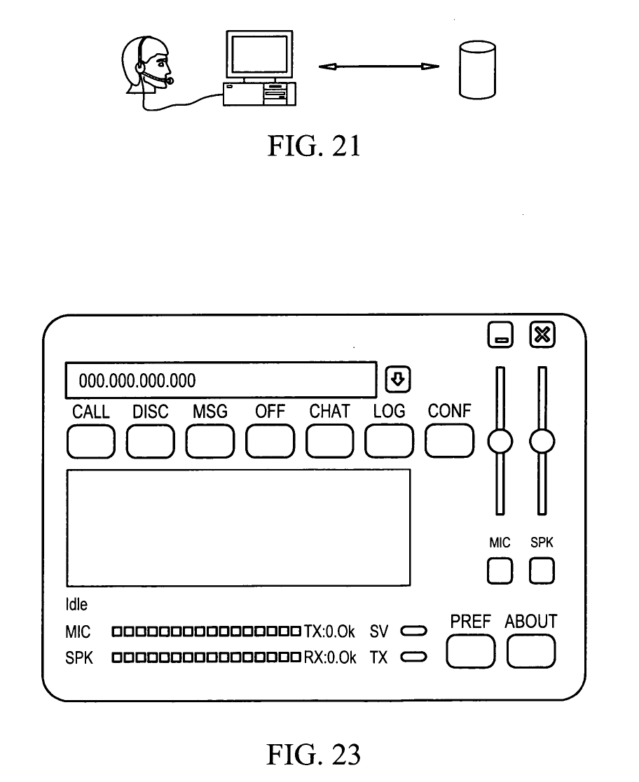

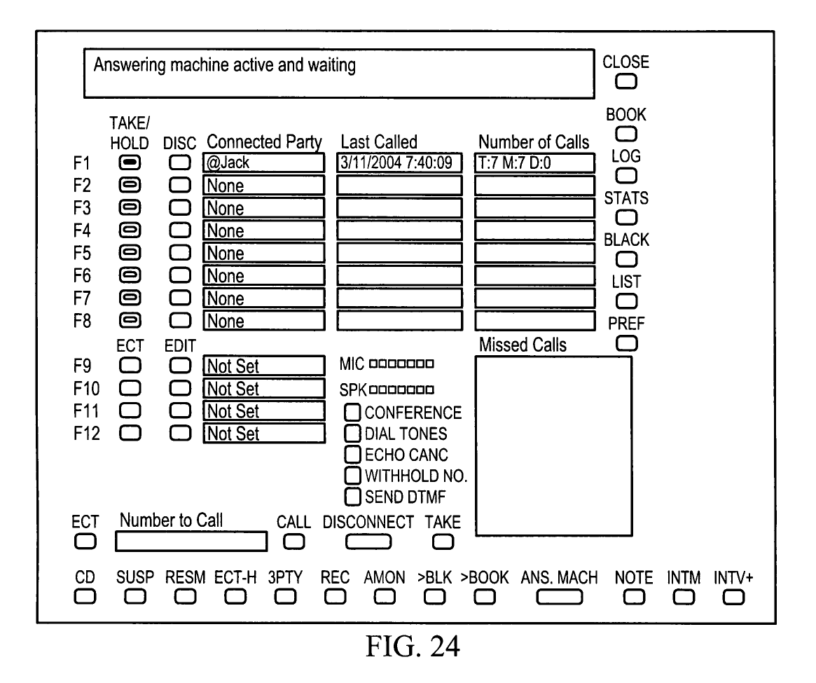

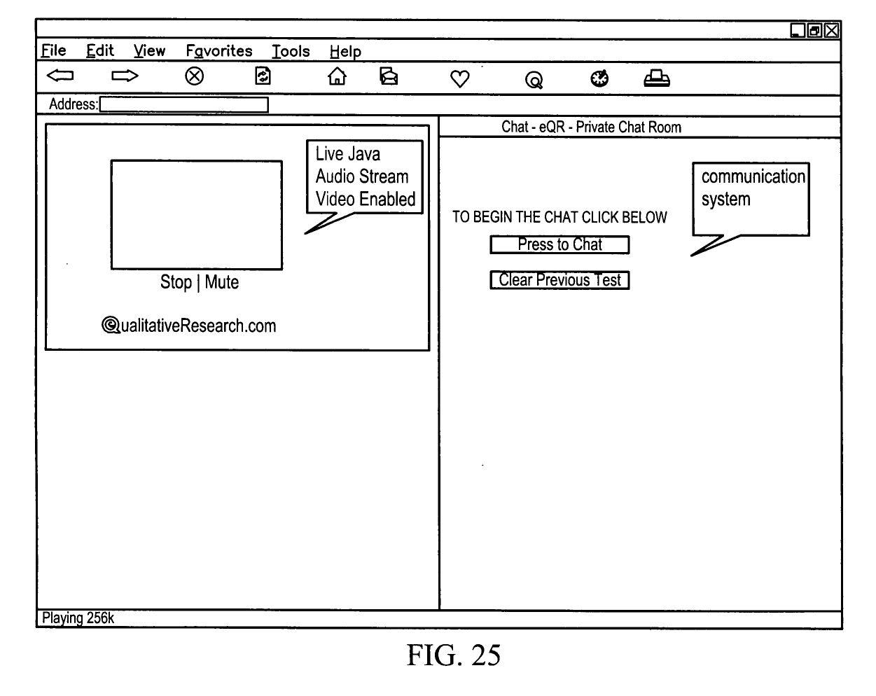

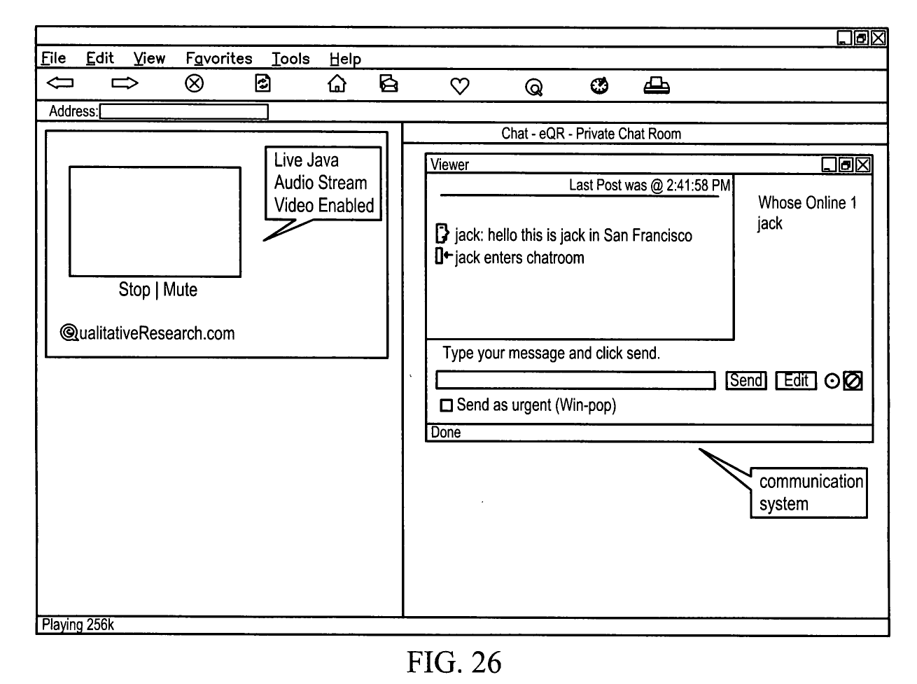

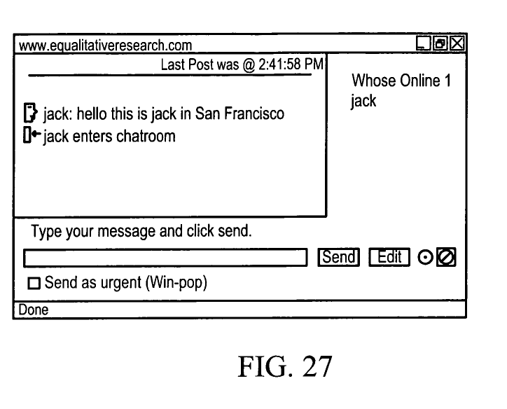

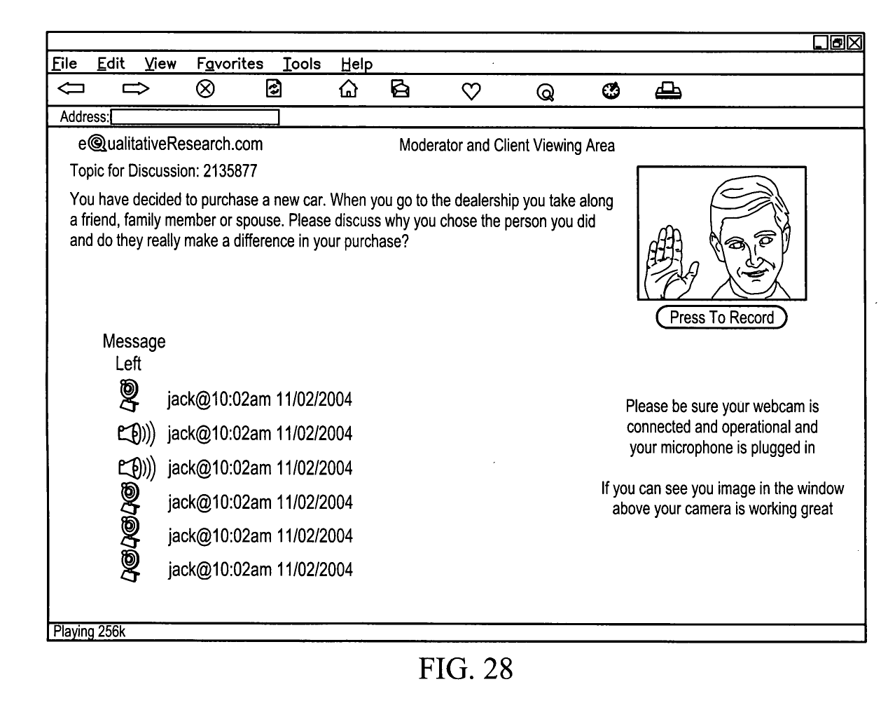

FIG. 21-32 illustrate further embodiment(s) of the present invention which provides for a market research methodology and system for conducting online (Internet) message boards. The system provides audio and video recording capabilities that can combine or encompass any various combinations thereof and which can permit for video and audio Synchronous and ASynchronal message boards. Preferably, in order to participate, a small endpoint application can be installed on the participant's computer, which allows for the authentication and protocols to access the connections to the servers used to run the present invention system. One or more participants can call into the call center server of the system and leave a recorded video and/or audio message based on any topic of discussion presented. Thus, recorded voice or a combination of both video and audio can be left by the participant(s). The call center system of the present invention can currently handle a plurality of simultaneous callers into the server, such as, but not limited to, up to eight (8) simultaneous callers. The calls can be monitored from a remote viewing station and the system can permit a moderator or other selected individual to select from a list of incoming participant callers to speak with live at that moment in time. The entire call can be recorded and stored in the call center server database for later playback.

A delivery system of all pre-recorded messages both video and audio to the moderator or client can also be provided by the present invention system. One non-limiting embodiment, the delivery system can be a hybrid HTML password protected website and can also be managed by the operator or owner of the call center servers. The call center can be designed to work with a modem connection, broadband connections, etc.

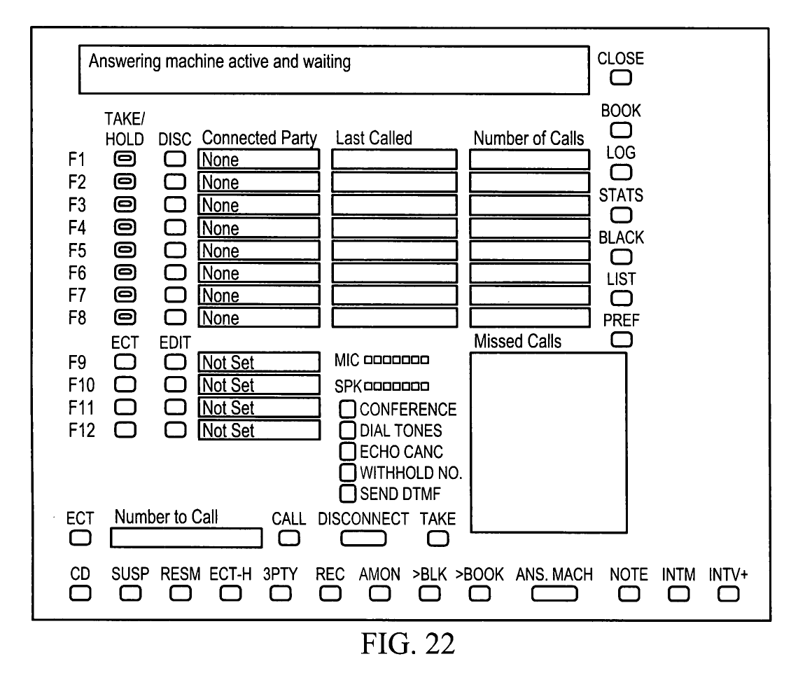

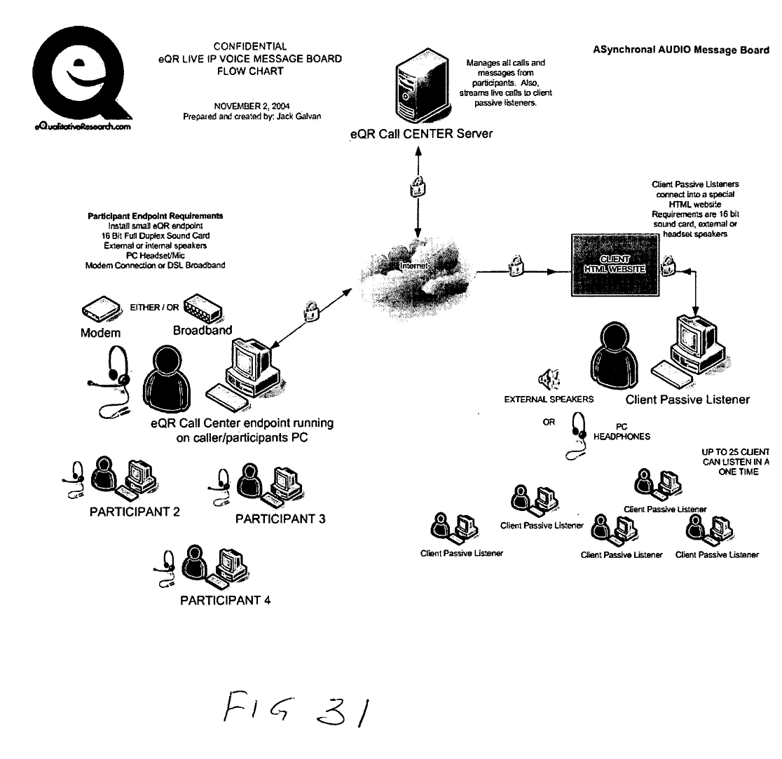

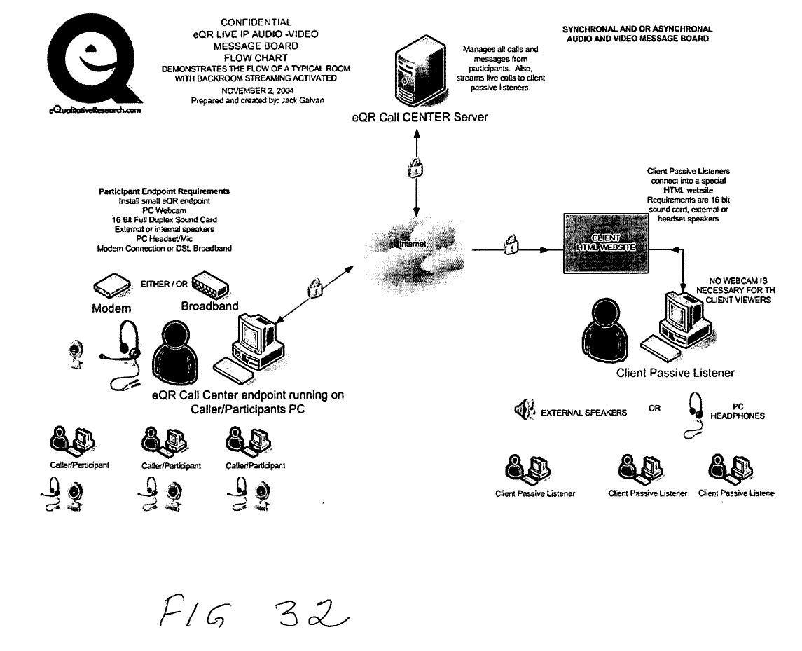

The overall system flow design is represented in FIGS. 31 and 32 for the embodiment of the present invention. The present invention system provides a two module Market Research Methodologies utilizing the internet voice and video capabilities. The first module can be an audio/voice message board. The present invention system can allow callers (participants) to call an IP Phone Call Center (see FIG. 22) and listen for a pre-recorded topic or instructional message, and then the participant is directed to leave a verbal response via their internet connection and headset microphone that can be provided to or otherwise obtained by the participant(s). When the participant or caller is finished they can close the connection. The topics of discussion can be controlled by a moderator or other individual, preferably according, though not limited to, a client's criteria or instructions. Recorded responses can be in any time length and can be based on the instructions given to the participants.

In one non-limiting embodiment, the system can have the capability (depending on Hard Drive space) for up to 1000 hours of recordings on a 200 Gigabit hard drive (FIG. 23). The recorded response can be held or otherwise stored or retained on a Call Center Data Base Server for later play back. A website, such as a HTML website can be provided to house and deliver the recorded verbal responses to the clients, moderator or any other permitted individual. Clients, moderators and other permitted individuals can log into a password protected website where they can select and play all the recorded messages at their leisure. The HTML website can also automatically refresh the participant's messages as they are recorded so that the newest messages can be inserted into the webpage.

Though not limiting, as mentioned above, the system can be designed to handle a plurality (e.g. up to eight) of simultaneous calls at any given time. This feature allows drastically reduces, if not eliminates, the possibility of busy signals to callers. The call center can handle all simultaneous calls as if they were individual in nature. The caller or participant leaves the verbal message as designed even if others are on the same IP line.

Though in one embodiment a software ISDN telephone can be used, the system can also be as a computer based hybrid, a complete calling center software, a front-end to a calling center software, a programmable auto responder, a VoIP-ISDN gateway, a PC front-end to a CTI enabled external phone, etc.

The system can preferably performed the following functions: (1) manage a plurality of internet calls (such as eight calls) with IP Phone protocols; (2) conference calls through integrated conference mixing bridge; (3) provide an integrated phonebook; (4) automatically save new numbers to the phonebook; (5) provide a complete log of incoming and outgoing calls; (6) provide statistics (e.g. total calls, calls in last 30 days, calls in last 7 days, calls today, differentiated for incoming, outgoing, answered, unanswered, for every number, etc.); (7) provide manual or automatic recording of calls in normal quality or enhanced quality (higher sampling frequency for operator voice—16, 32 or 48 kHz), in mono or stereo (operator to one channel, connected party to the other); (8) provide a programmable answering machine, folder based, which can react to user input via DTMF keys, respond to user requests, record messages or alert the operator; (9) monitoring of calls on answering machine; (10) automatic reaction on incoming calls based on the calling or called number, or IP Phone sub address: alert operator (default), refuse call, deflect to number, deflect to answering machine folder, call link via integrated router to another ISDN or internet line; (11) call transfer/link to a number or call transfer/link to a held call; (12) provide a link function that can route ISDN calls via the internet to another ISDN line; (13) provide fast buttons (such as, but not limited to four buttons) for call transfer to predefined numbers; (14) provide a software echo canceller, which does not require special CTI-enabled ISDN adapters; (15) provide a calling list that can continuously call a list of numbers until somebody answers; (16) provide a reminder function that can reminds that a call has to be made at a predefined time; and/or (17) provide an interview function that can present the operator a list of programmed questions and that can save the output to a text file.

The system can also provide the following ISDN supplementary services: (1) Calling Line Identification Presentation; (2) Calling Line Identification Restriction; (3) Connected Line Identification Presentation; (4) Connected Line Identification Restriction; (5) Direct Dial In; (6) Sub addressing; (7) User to user signaling; (8) Advice of charge; (9) Call waiting; (10) Call hold; (11) Call deflection; (12) Three party conference; (13) Terminal portability (Suspend and Resume calls); (14) Explicit call transfer.

Any one of a plurality of operating systems or web browsers can be used for the present invention system. In one non-limiting embodiment, a Microsoft Windows Operating system can be used and the system can utilize a Microsoft Internet Explorer 5.5 or above version. These platforms are also preferred, at least at the moment, since they currently represent the majority of market penetration in both the corporate world and home based computers. It has been estimated that over 98% of all computers used today in business and homes are Microsoft Windows platforms. This extensive penetration in the market can allow for the most extensive and cost-effective participants and clients reach and currently allows the features of the present invention system to be used by a wide, expansive, world-wide basis.

On the participant side, a small application (IP endpoint) can be installed on a participant's computer in order for the participant to connect to the IP servers of the present invention system. The small application can be installed via a web link on the server and can install in under four minutes. Other methods of delivering (i.e. CD-Rom, disk) the endpoint application to the participant for installation on his or her computer can also be used and are considered within the scope of the invention. When started the IP endpoint invokes the participants installed application and connects the participant to the IP server of the present invention system. The participant can enter an IP address that is provided by the server owners via an email. FIG. 22 depicts the IP endpoint activated and an IP address entered in the call window. The participant can then select “CALL” from the IP endpoint and contact the server for authentication.

The second module can be a video/audio Message Board. This module can allow for video and audio recordings of participants that call into the Call Center. Pre-screened callers or participants can be directed to call into the Call Center Server, where they can be authenticated. Once verified the participant can be taken to a specified area where the participant or caller can leave a video and/or audio recording.

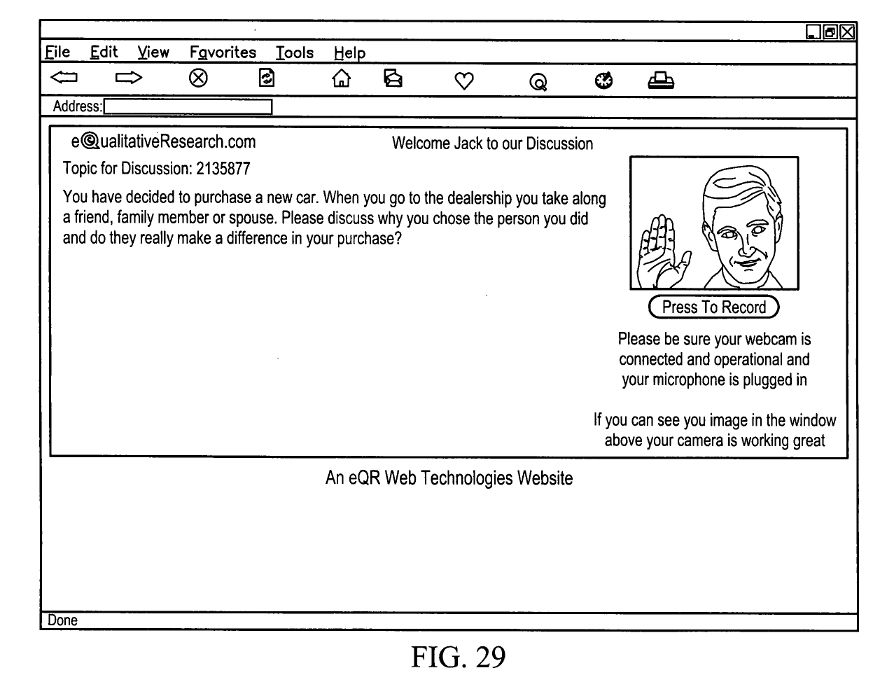

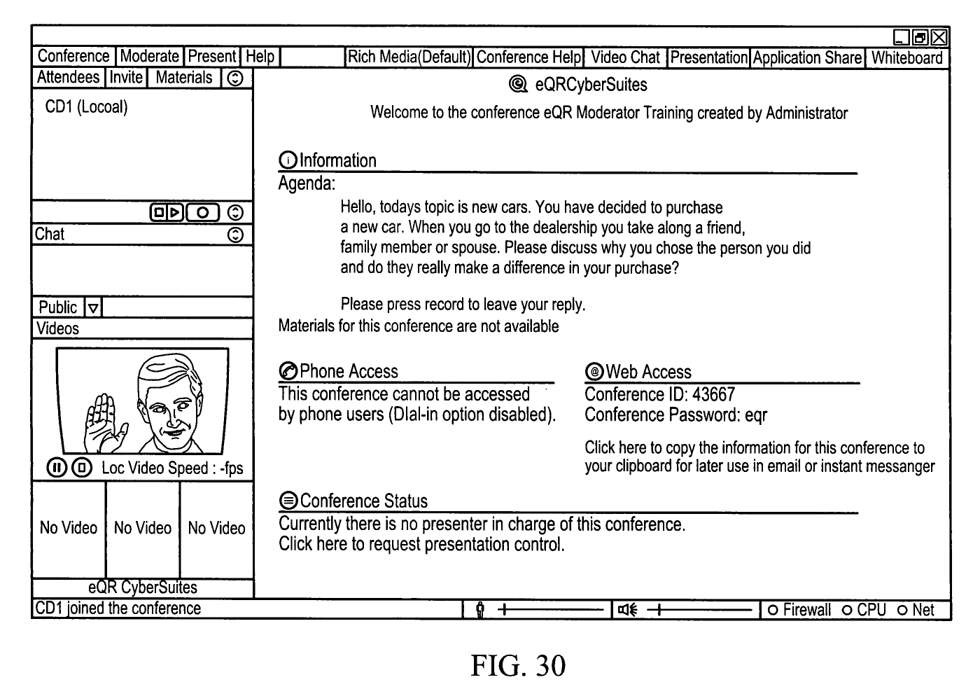

As shown in FIGS. 29 and 30 two methods of entry can be provided (1) the HTML direct entry method (FIG. 29) and (2) endpoint application method (FIG. 30). the participant callers can simply click at the appropriate location to record their video and audio reply. In one embodiment, the system can interface with other videoconferencing platforms such as, but not limited to, Polycom Systems. Other operating systems such as, but not limited to Macintosh, Linux and Sun Solaris can also be used with the present invention.

In non-limiting a hardware/software configuration for the present invention system can include on the Server Side—Windows 2003 Server or Windows 2000 Server; P4 2.8 GHz or above; 1 Gig Memory; 200 Meg Hard Drive or above; 100 Meg. Full Duplex NIC; 16 Bit Full Duplex Sound Card; and IIS 6 Web Server. The IP endpoint can be currently compatible with the most widely used operating systems, such as, but not limited to Microsoft Operating Systems (Windows 2000 Professional, Windows XP Home Edition, and/or Windows XP Professional Edition). The IP endpoint can be designed to support a plurality of browsers, including but not limited to the following Web Browsers: Internet Explorer 5.5 and later. In one non-limiting embodiment, the conference client can run on the following computer configuration: CPU Pentium III 800 MHz or higher; RAM 128M or higher; 16 bit full duplex sound card; and network card NIC card for broadband.

Module 2 Video/Audio Message Board and Module 1 Voice/Audio Message Board can be designed for use in the Market Research Industry. However, the Call Center can be integrated into other various industries, such as, but not limited to, Medical Applications, Legal Applications, Internal Business Applications, Software Application, Research and Development, etc., and all are considered within the scope of the invention.

In all embodiments the term moderator is considered non-limiting and can be any person(s) in charge or responsible for running or conducting the question session, the interviewer, interrogator, questioner, showing the stimuli, etc. The participant or respondent is also non-limiting and is considered the person(s) responsible for answering the questions from the moderator or commenting on the stimuli.

While the invention has been particularly shown and described with reference to preferred embodiments thereof, it will be understood by those skilled in the art that various changes in form and details may be made therein without departing from the spirit and scope of the invention.

What is claimed is:

1. A system for conducting an online research over a distributed computer network, comprising: a moderator device having distributed computer network access, an audio/video recording mechanism, and an input mechanism wherein moderators submit stimulus to users across the distributed computer network; a user device having distributed computer network access, an audio/video recording mechanism, and an input mechanism wherein users submit market research responses in response to the moderator's submitted stimulus; and a host machine communicating over the distributed computer network and having a database accumulating user responses to the moderator's submitted stimulus, a processor evaluating user responses, and an engine outputting research results.

2. The system as in claim 1, further comprising, at least one sponsoring client device having distributed computer network access wherein at least one sponsoring client accessing the online research a given time observes the submitted moderator stimuli and the submitted user responses.

3. The system as in claim 1, wherein a user working from the user device observes a moderator working from a moderating device, the submitted moderator stimuli, and the submitted user response.
